(19) United States
(12) Patent Application Publication
(10) Pub. No.: US 2025/0220579 A1
(43) Pub. Date: Jul. 3, 2025

(54) Methods And Apparatus For Internet-Of-Things Signal Transmission In Mobile Communications

(71) Applicant: MediaTek Inc., Hsinchu City (TW)

(72) Inventors: Chien-Chun Cheng, Hsinchu City (TW); Chiou-Wei Tsai, Hsinchu City (TW); You-Wei Chen, San Jose, CA (US); Chiao-Yao Chuang, Hsinchu City (TW); Tai-Cheng Tsai, Hsinchu City (TW); Wei-De Wu, Hsinchu City (TW); JunQiang Cheng, Beijing (CN); Tao Chen, Beijing (CN)

(21) Appl. No.: 18/984,809

(22) Filed: Dec. 17, 2024

(30) Foreign Application Priority Data
Dec. 27, 2023 (WO) PCT/CN2023/142296
Feb. 18, 2024 (WO) PCT/CN2024/077448
Nov. 21, 2024 (CN) 202411675770.6

(51) Int. Cl. H04W 52/02; H04L 67/12; H04W 56/00

(52) U.S. Cl. CPC H04W 52/0229; H04L 67/12; H04W 56/0015

(57) ABSTRACT

Various solutions for Internet of Things (IoT) signal transmission with respect to reader apparatus and an IoT device are described. A reader apparatus may transmit a message to an IoT device through an in-band frequency or a guard band frequency in a frequency spectrum for an orthogonal frequency division multiplexing (OFDM) signal. A start of the transmission is aligned with a boundary of an OFDM symbol of the OFDM signal. The reader apparatus may receive a backscattered IoT signal from the IoT device through the in-band frequency or the guard band frequency.

### CROSS REFERENCE TO RELATED PATENT APPLICATION(S)

The present disclosure is part of a non-provisional application claiming the priority benefit of PCT Application No. PCT/CN2023/142296, filed 27 Dec. 2023, PCT Application No. PCT/CN2024/077448, filed 18 Feb. 2024, and CN application Ser. No. 20/241,1675770.6, filed 21 Nov. 2024. The contents of aforementioned applications are herein incorporated by reference in their entirety.

### TECHNICAL FIELD

The present disclosure is generally related to mobile communications and, more particularly, to internet of things (IoT) signal transmission with respect to reader apparatus and IoT device in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G long term evolution (LTE) standard. There exists a need for further improvements in 5G NR technology. These improvements may also be applicable to other multi-access technologies and the telecommunication standards that employ these technologies.

However, in frequency division duplexing (FDD) networks, the IoT devices using the same frequencies for communication may face the challenges due to the potential interference with the UE behavior. Therefore, effective solutions may be needed to manage the timing and configure the frequency bands to ensure that the IoT signals will not interfere or be interfered by the UL and downlink (DL) operations of the UE within the same frequency spectrum.

Accordingly, how to transmit the IoT signal in the wireless communication environments such 5G NR becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to Internet of Things (IoT) signal transmission with respect to reader apparatus and IoT device in mobile communications. It is believed that the above-described issue would be avoided or otherwise alleviated by implementing one or more of the proposed schemes described herein.

In one aspect, a method may involve a reader apparatus transmitting a message to an IoT device through an in-band frequency or a guard band frequency in a frequency spectrum for an orthogonal frequency division multiplexing (OFDM) signal, wherein a start of the transmission is aligned with a boundary of an OFDM symbol of the OFDM signal. The method may also involve the reader apparatus receiving a backscattered IoT signal from the IoT device through the in-band frequency or the guard band frequency.

In another aspect, a method may involve an IoT device receiving a message from a reader apparatus through an in-band frequency or a guard band frequency in a frequency spectrum for an OFDM signal, wherein a start of the reception is aligned with a boundary of an OFDM symbol of the OFDM signal. The method may also involve the IoT device performing a backscattering transmission through the in-band frequency or the guard band frequency to transmit a backscattered IoT signal to the reader apparatus.

In another aspect, a reader apparatus may involve a transceiver which, during operation, wirelessly communicates with at least one network node. The apparatus may also involve a processor communicatively coupled to the transceiver such that, during operation, the processor may transmit a message to an IoT device through an in-band frequency or a guard band frequency in a frequency spectrum for an OFDM signal, wherein a start of the transmission is aligned with a boundary of an OFDM symbol of the OFDM signal. The processor may also receive, via the transceiver, a backscattered IoT signal from the IoT device through the in-band frequency or the guard band frequency.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for an A-IoT transmission architecture in accordance with implementations of the present disclosure.

FIG. 3 is a diagram depicting another example scenario for an A-IoT transmission architecture in accordance with implementations of the present disclosure.

FIG. 4 is a diagram depicting an example scenario for a reader apparatus or an IoT device in accordance with implementations of the present disclosure.

FIG. 5 is a diagram depicting another example scenario for a reader apparatus or an IoT device in accordance with implementations of the present disclosure.

FIG. 6 is a diagram depicting another example scenario for a reader apparatus or an IoT device in accordance with implementations of the present disclosure.

FIG. 7 is a diagram depicting an example scenario for a communication process in accordance with implementations of the present disclosure.

FIG. 8 is a diagram depicting an example scenario for an in-band frequency configuration in a frequency spectrum for DL communication in accordance with implementations of the present disclosure.

FIG. 9 is a diagram depicting an example scenario for a guard band frequency configuration in a frequency spectrum for DL communication in accordance with implementations of the present disclosure.

FIG. 10 is a diagram depicting an example scenario for an in-band frequency configuration in a frequency spectrum for UL communication in accordance with implementations of the present disclosure.

FIG. 11 is a diagram depicting an example scenario for a guard band frequency configuration in a frequency spectrum for UL communication in accordance with implementations of the present disclosure.

FIG. 12 is a diagram depicting an example scenario for an A-IoT communication architecture in accordance with implementations of the present disclosure.

FIG. 13 is a diagram depicting another example scenario for an A-IoT communication architecture based on the DFT-s-OFDM in accordance with implementations of the present disclosure.

FIG. 14 is a diagram depicting another example scenario for an A-IoT communication architecture in accordance with implementations of the present disclosure.

FIG. 15 is a diagram depicting another example scenario for an A-IoT communication architecture in accordance with implementations of the present disclosure.

FIG. 16 is a diagram depicting another example scenario for an A-IoT communication architecture in accordance with implementations of the present disclosure.

FIG. 17 is a diagram depicting another example scenario for an A-IoT communication architecture in accordance with implementations of the present disclosure.

FIG. 18 is a diagram depicting an example scenario for a communication process within an FDD network in accordance with implementations of the present disclosure.

FIG. 19 is a diagram depicting another example scenario for a communication process within an FDD network in accordance with implementations of the present disclosure.

FIG. 20 is a diagram depicting an example scenario for a transmission in an HDX system in accordance with implementations of the present disclosure.

FIG. 21 is a diagram depicting an example scenario for a transmission in an FDX system in accordance with implementations of the present disclosure.

FIG. 22 is a diagram depicting an example scenario for a communication process in accordance with implementations of the present disclosure.

FIG. 23 is a diagram depicting an example scenario for a heterogeneous network deployment in accordance with implementations of the present disclosure.

FIG. 24 is a diagram depicting an example scenario for a network deployment scenario in accordance with implementations of the present disclosure.

FIGS. 25A-25B are diagrams depicting an example scenario for a band aggregation process in accordance with implementations of the present disclosure.

FIG. 26 is a diagram depicting an example scenario for a UE reader configuration for different communication layers in accordance with implementations of the present disclosure.

FIGS. 27A-27B are diagrams depicting an example scenario for a communication process for different communication layers in accordance with implementations of the present disclosure.

FIG. 28 is a diagram depicting an example scenario for different communication formats in accordance with implementations of the present disclosure.

FIGS. 29A-29B are diagrams depicting an example scenario for a communication process for different communication formats in accordance with implementations of the present disclosure.

FIG. 30 is a diagram depicting an example scenario for frame structures in accordance with implementations of the present disclosure.

FIG. 31 is a diagram depicting an example scenario for a sequence of operations associated with the A-IoT device in accordance with implementations of the present disclosure.

FIG. 32 is a diagram depicting an example scenario for different configuration strategies in accordance with implementations of the present disclosure.

FIG. 33 is a diagram depicting another example scenario for a sequence of operations associated with the A-IoT device in accordance with implementations of the present disclosure.

FIGS. 34A-34B are diagrams depicting an example scenario for a communication process for the A-IoT device in accordance with implementations of the present disclosure.

FIGS. 35A-35B are diagrams depicting another example scenario for a communication process for the A-IoT device in accordance with implementations of the present disclosure.

FIG. 36 is diagram depicting another example scenario for a communication process for the A-IoT device in accordance with implementations of the present disclosure.

FIG. 37 is diagram depicting another example scenario for a communication process for the A-IoT device in accordance with implementations of the present disclosure.

FIG. 38 is diagram depicting another example scenario for a communication process for the A-IoT device in accordance with implementations of the present disclosure.

FIGS. 39A-39B are diagrams depicting another example scenario for a communication process for the A-IoT device in accordance with implementations of the present disclosure.

FIG. 40 is diagram depicting an example scenario for a communication process for different communication formats in accordance with implementations of the present disclosure.

FIG. 41 is a block diagram of an example communication system in accordance with an implementation of the present disclosure.

FIG. 42 is a flowchart of an example process in accordance with an implementation of the present disclosure.

FIG. 43 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to Internet of Things (IoT) signal transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

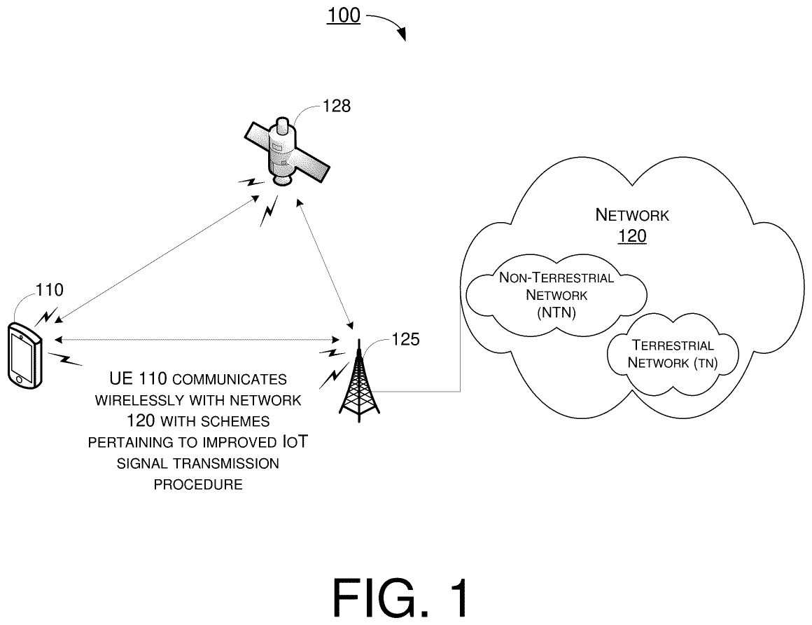

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to improved IoT signal transmission procedure in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a reader apparatus (e.g., UE 110) may transmit a message to an IoT device through an in-band frequency or a guard band frequency in a frequency spectrum for an orthogonal frequency division multiplexing (OFDM) signal (e.g., NR frequency spectrum). A start of the transmission may be aligned with a boundary of an OFDM symbol of the OFDM signal. Then, the reader apparatus may receive a backscattered IoT signal from the IoT device through the in-band frequency or the guard band frequency.

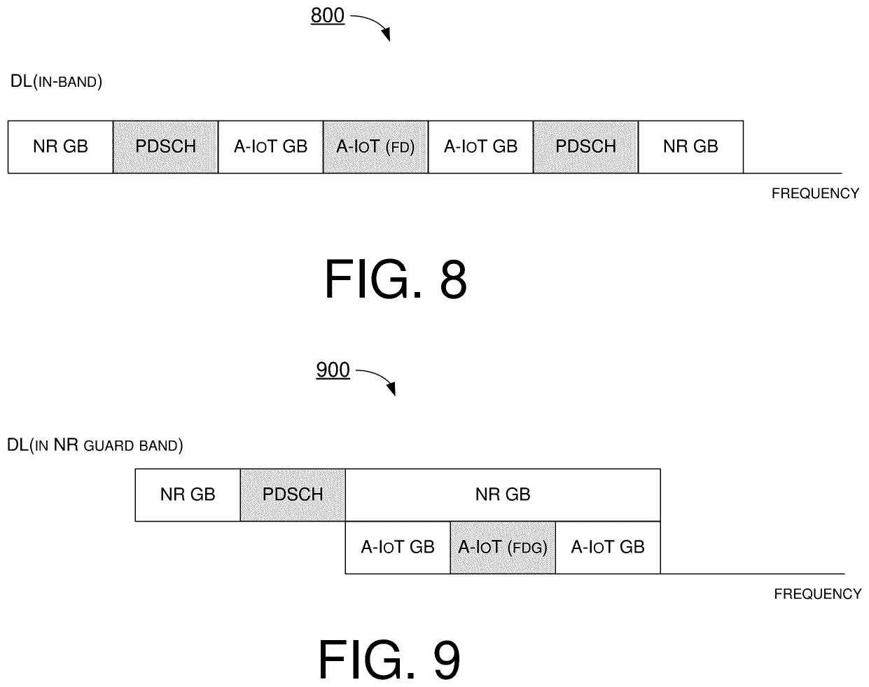

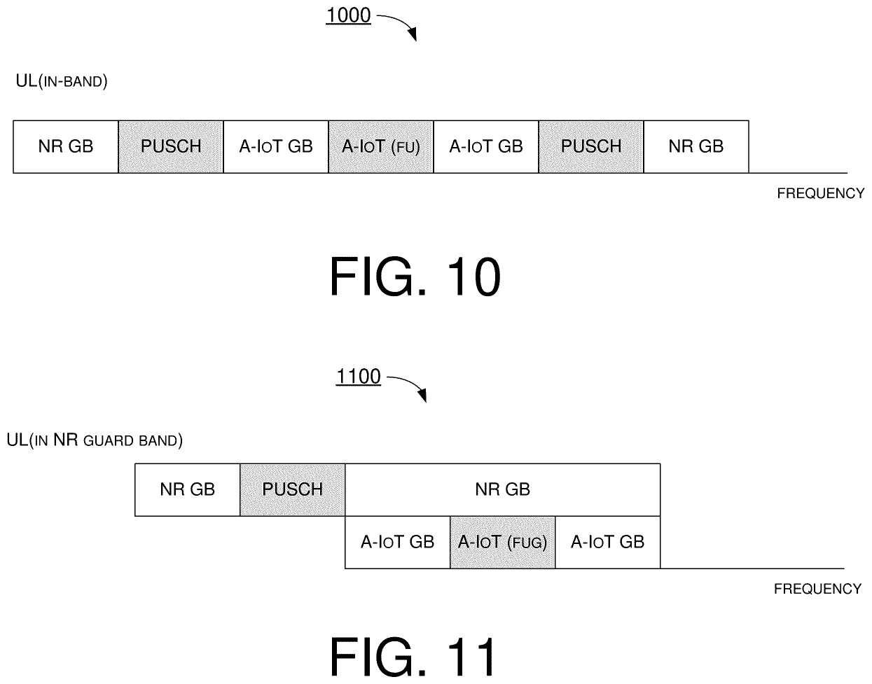

In an implementation, the in-band frequency may be configured for an uplink (UL) transmission or a downlink (DL) transmission of the OFDM signal (e.g., the ‘fd’ or ‘fu’ respectively shown in FIG. 8 and FIG. 10).

In an implementation, the guard band (GB) frequency may be configured between two OFDM signals (e.g., the ‘fdg’ and ‘fug’ respectively shown in FIG. 9 and FIG. 11).

In an implementation, an IoT guard band is configured between the OFDM signal and an IoT signal (e.g., the ‘A-IoT GB’ shown in FIGS. 8-11).

In an implementation, the reader apparatus may transmit a carrier waveform (CW) to the IoT device. The CW may be configured to provide energy to the IoT device.

In an implementation, the CW may be transmitted in at least one of an UL spectrum and a DL spectrum for the OFDM signal. In an example, the CW may be transmitted from inside a system/topology for the OFDM signal in the DL spectrum. In another example, the CW may be transmitted from inside the system/topology for the OFDM signal in the UL spectrum. In another example, the CW may be transmitted from outside the system/topology for the OFDM signal in the UL spectrum. The system/topology may be an NR system comprising at least an IoT device, a reader, and a network node. For example, when the device-to-reader (D2R) backscattering is transmitted in the same carrier as CW for the D2R backscattering, for the topology 1, the CW may be transmitted from inside the topology and transmitted in DL spectrum, the CW may be transmitted from inside the topology and transmitted in UL spectrum, or the CW may be transmitted from outside the topology and transmitted in UL spectrum.

In an implementation, the CW may be transmitted through a carrier resource of the message (e.g., format 1 of FIG. 28) or through another carrier resource (e.g., format 2 of FIG. 28).

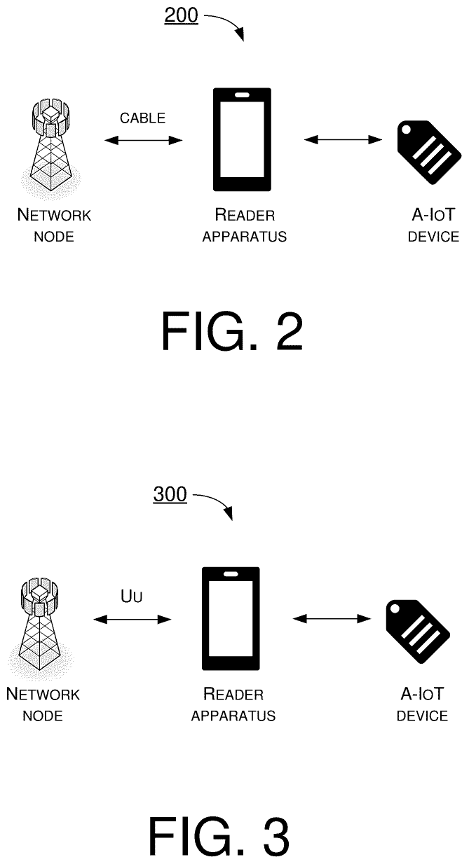

FIG. 2 illustrates an example scenario 200 for an A-IoT transmission architecture in accordance with implementations of the present disclosure. Scenario 200 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 2, the network node (e.g., a next-generation nodeB (gNB)) may establish a connection with the reader apparatus (e.g., a UE or a UE reader) via a wired cable. The configuration may eliminate the requirement for a new air interface between the network node and the A-IoT device. A new air interface between the reader apparatus and the A-IoT device may not be introduced. As shown in FIG. 2, the network node can access the A-IoT device via the reader apparatus. That is, the reader apparatus may be an intermediate node between the A-IoT device and the network node.

FIG. 3 illustrates another example scenario 300 for an A-IoT transmission architecture in accordance with implementations of the present disclosure. Scenario 300 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 3, the network node (e.g., a gNB) may establish a connection with the reader apparatus (e.g., a UE or a UE reader) via a wireless air interface. The air interface may be an NR-Uu interface to minimize the specification change on the reader apparatus. In addition, the air interface between the reader apparatus and the A-IoT device may be determined based on the use cases and requirements corresponding to the reader apparatus and the A-IoT device.

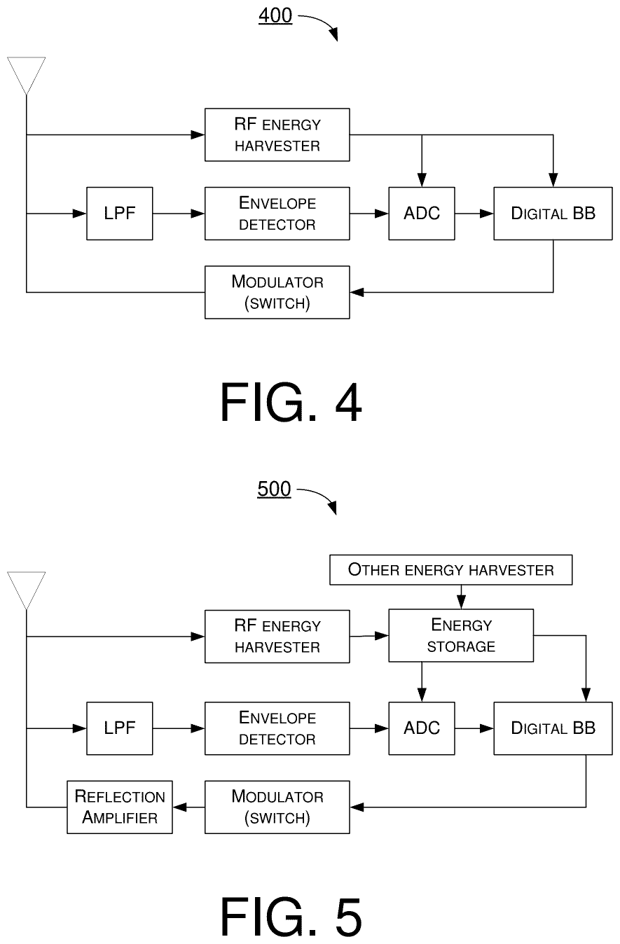

FIG. 4 illustrates an example scenario 400 for a reader apparatus or an IoT device in accordance with implementations of the present disclosure. Scenario 400 involves a reader apparatus. Referring to FIG. 4, the IoT device may be designed with specific targets. The IoT device may be designed for power consumption during transmission or reception (≤1 μW or ≤10 μW), and for complexity, which is aimed to be comparable to ultra-high-frequency radio-frequency-identification (UHF RFID) ISO18000-6C (EPC C1G2). In addition, as shown in FIG. 4, the IoT device may not have energy storage or independent signal generation and amplification capabilities. The IoT device may rely on backscattering transmission. The IoT device may require a backscattering activation power threshold, experience reflection loss, and need a distant carrier wave source to transmit signals for positioning. As shown in FIG. 4, the IoT device may comprise a low pass filter (LPF) for suppressing adjacent sub-carrier interference (ASCI) and adjacent carrier interference (ACI). The IoT device may also comprise an envelope detector (ED) to support OOK-based signals. The IoT device may also comprise an analog to digital converter (ADC) for digital baseband processing. The IoT device may also comprise a digital baseband (DBB) for sequence matching. The IoT device may also comprise a modulator (or a switch) controlled by the incoming signal to add payload data for OOK modulation. The IoT device may also comprise a radio frequency energy harvester to convert radio frequency (RF) signals into an energy source.

FIG. 5 illustrates another example scenario 500 for a reader apparatus or an IoT device in accordance with implementations of the present disclosure. Scenario 500 involves a reader apparatus. Referring to FIG. 5, the IoT device may be designed with specific targets. In addition, as show in FIG. 5, the IoT device may have energy storage but not have independent signal generation. The IoT device may rely on backscattering transmission. The stored energy may be used for signal amplification. The IoT device may also require a backscattering activation power threshold, experience reflection loss, and need a distant carrier wave source for positioning. As shown in FIG. 5, the IoT device may comprise an LPF for suppressing ASCI and ACI. The IoT device may also comprise an ED to support OOK-based signals. The IoT device may also comprise an ADC for digital baseband processing. The IoT device may also comprise a DBB for sequence matching. The IoT device may also comprise a modulator controlled by the incoming signal to add payload data for OOK modulation. The IoT device may also comprise an RF energy harvester to convert RF signals into an energy source. The IoT device may also comprise additional energy harvesters for different types of ambient power sources, such as RF radio, solar energy, thermal energy, and piezoelectric power. The IoT device may also comprise an energy storage, such as capacitors and solid-state batteries. The IoT device may also comprise a reflection amplifier to amplify the input signal to the tag and the backscattered signal towards the reader apparatus.

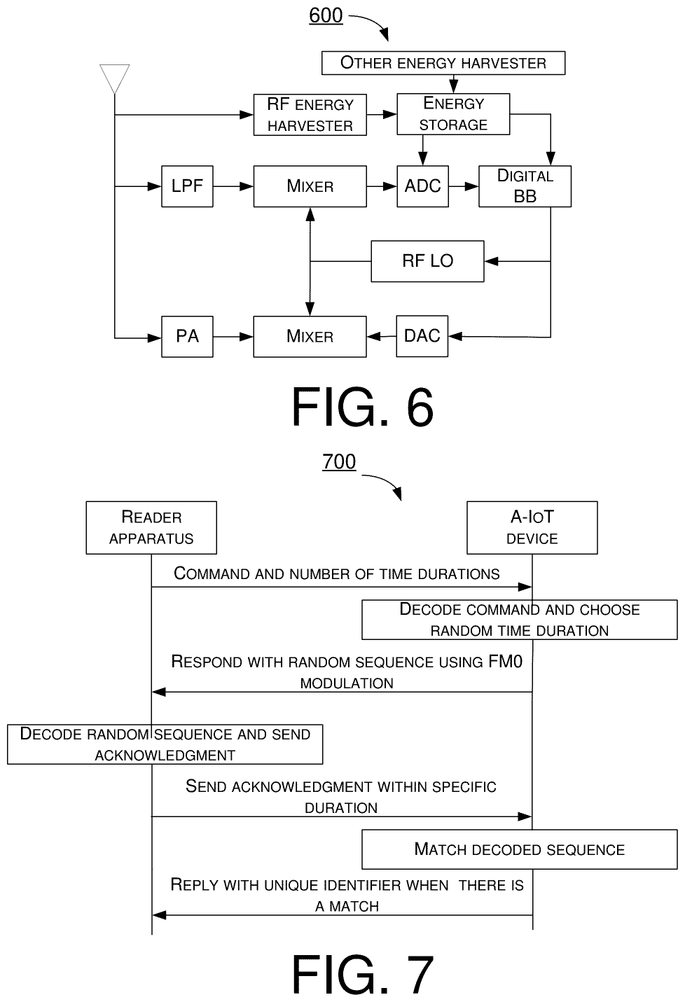

FIG. 6 illustrates another example scenario 600 for a reader apparatus or an IoT device in accordance with implementations of the present disclosure. Scenario 600 involves a reader apparatus. Referring to FIG. 6, the IoT device may be designed with specific targets. For example, the IoT device may be designed for a power consumption during transmission or reception (≤1 mW to ≤10 mW), and for a complexity that is orders-of-magnitude lower than Narrow Band IoT (NB-IoT). In addition, as shown in FIG. 6, the IoT device may have energy storage, independent signal generation, and active RF components for transmission. The IoT device may also have mobility management capabilities, at least for cell selection and re-selection. As shown in FIG. 6, the IoT device may comprise an LPF for suppressing ASCI and ACI. The IoT device may also comprise an ED to support OOK-based signals. The IoT device may also comprise an ADC for digital baseband processing. The IoT device may also comprise a DBB for synchronization, payload decoding, and cyclic redundancy check (CRC). The IoT device may also comprise an RF energy harvester to convert RF signals into an energy source. The IoT device may also comprise additional energy harvesters for different types of ambient power sources, such as RF radio, solar energy, thermal energy, and piezoelectric power. The IoT device may also comprise an energy storage, such as capacitors and solid-state batteries. The IoT device may also comprise a low-noise amplifier (LNA) and power amplifier (PA) to amplify reception and transmission signals.

FIG. 7 illustrates an example scenario 700 for a communication process in accordance with implementations of the present disclosure. Scenario 700 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 7, there may be an innovative air interface for communication between the reader apparatus (e.g., a UE reader or a network node (e.g., a gNB)) and the A-IoT device. As shown in FIG. 7, the communication process may be initiated when the reader apparatus powers up the A-IoT device and transmits a command. The command may comprise the essential communication parameters, e.g., the tag rate, the tag data encoding method, and the total number of available time durations. When the A-IoT device has harvested enough energy, the A-IoT device may be activated and listen for the command from the reader apparatus. After the A-IoT device decode the command, the A-IoT device may randomly select a time duration from the available range, and generate a random sequence. Then, the A-IoT device may transmit the random sequence to the reader apparatus in the chosen time duration. The random sequence may be modulated by frequency modulation 0 (FM0), and the random sequence may be preceded by a known preamble sequence. In response to the random sequence from the A-IoT device, the reader apparatus may decode the random sequence and send an acknowledgment back to the A-IoT device within a predetermined duration aligning with the configuration for the A-IoT rate. The reader apparatus discussed above may be a node, e.g., a UE, a UE reader a relay, IAB node, NR/LTE UE, repeater, or a base station (gNB).

According to an implementation of the present disclosure, the UE-to-A-IoT device communication link (U2A Link) may use modulation scheme like amplitude shift keying (ASK) or OOK to facilitate pulse interval encoding (PIE) for data transmission. The U2A link may include two preambles. One preamble is a long U2A preamble for initial transmission and the other preamble is a short U2A preamble for subsequent signaling. The UE may transmit the long U2A preamble and a control signal (or command) which is specifies the control parameters for the A-IoT device to the A-IoT device.

According to an implementation of the present disclosure, the A-IoT device-to-UE communication link (A2U Link) may use either ASK or phase shift keying (PSK) modulation. The A-IoT may encode backscattered data using either FM0 baseband or Miller modulation which is controlled by the UE or gNB via the A2U link. The A2U link signaling may be initiated with one of two Miller subcarrier preambles based on the command or the control signal. The A-IoT device may use backscatter modulation based on its antenna's reflection coefficient to transmit data. The A2U link may be used to transmit electronic product code (EPC) and protocol-control (PC) information.

According to implementations of the present disclosure, in frequency division duplexing (FDD) networks, the A-IoT devices using the uplink (UL) frequencies for communication may face the challenges due to the potential interference with the UE behavior. Therefore, effective solutions may be needed to manage the timing and configure the guard bands to ensure that the A-IoT signals do not interrupt the UL and downlink (DL) operations of the UE within the same frequency spectrum.

FIG. 8 illustrates an example scenario 800 for an in-band frequency configuration in a frequency spectrum for DL communication in accordance with implementations of the present disclosure. Scenario 800 involves an A-IoT device and a reader apparatus (e.g., a network node or a UE). Referring to FIG. 8, the DL frequency used by the A-IoT device may be denoted as ‘fd’. The A-IoT device may receive query commands from the reader apparatus (e.g., a UE reader or a gNB) through the DL frequency of the frequency spectrum for DL communication. When the A-IoT device receives the command, the A-IoT device may use a backscattering technique to communicate with the reader apparatus. Specifically, the A-IoT device may reflect and modulate the incoming DL frequency signal to transmit its response through the same DL frequency ‘fd’. As shown in FIG. 8, the A-IoT device may not generate its own signal. Therefore, the power may be conserved and the complexity may also be reduced.

Referring to FIG. 8, in order to reduce the intra-cell interference which may occur when the A-IoT signal is close to other subcarriers used for the cellular communication (e.g., the physical downlink shared channel (PDSCH)), the A-IoT guard bands (A-IoT GBs) may be configured in the frequency spectrum for DL communication. The A-IoT GBs may form a buffer zone between the A-IoT backscatter signal and the PDSCH. Therefore, the interference from the nearby sub-carriers can be effectively prevented. The network node may configure the A-IoT GB. The network node may determine the size of the A-IoT GB from zero to two resource elements (REs) wide according to the requirements of the deployment. The configuration of the A-IoT GB may be transmitted to both the A-IoT device and the UE reader through the system information (SI) or Radio Resource Control (RRC) messages to ensure that the A-IoT device and the UE reader can be synchronized in the spectrum and maintain the integrity of the A-IoT communication channel.

FIG. 9 illustrates an example scenario 900 for a guard band frequency configuration in a frequency spectrum for DL communication in accordance with implementations of the present disclosure. Scenario 900 involves an A-IoT device and a reader apparatus (e.g., a network node or a UE). Referring to FIG. 9, the A-IoT device may use the guard band frequency (e.g., the guard bands of NR) in a cellular network for communication to mitigate the inter-cell interference. The guard band frequency may be referred to as DL NR guard bands (NR GBs). The guard band frequency may be configured on both sides of the configured channel bandwidth (e.g., 100 MHz or 20 MHZ). Within the guard band frequency, the reader apparatus (e.g., a UE reader or a gNB) may broadcast a query command through a dedicated DL frequency (or A-IoT frequency) which is labeled as ‘fdg’. The dedicated DL frequency may be selected from the guard band frequency which may provide the interference protection.

Referring to FIG. 9, the A-IoT GBs surrounding the A-IoT frequency ‘fdg’ may be configured to enhance this interference protection. The A-IoT GBs may be a further safeguard against the potential inter-cell interference which may be from the neighboring cells. The network node may configure the A-IoT GBs to span from zero to six REs according to the requirement for the interference mitigation. The configuration of the A-IoT GBs may be transmitted to the A-IoT device and the UE reader through the system information (SI) broadcasts or the RRC messages. The configuration of the A-IoT GBs may be used to ensure that both the A-IoT device and the UE reader can operate within the parameters set by the network node to prevent the interference from the adjacent cells and maintain the robust A-IoT communication.

FIG. 10 illustrates an example scenario 1000 for an in-band frequency configuration in a frequency spectrum for UL communication in accordance with implementations of the present disclosure. Scenario 1000 involves an A-IoT device and a reader apparatus (e.g., a network node or a UE). Referring to FIG. 10, the A-IoT device may use the UL frequency for communication within the frequency spectrum for UL communication of a cellular network. The UL frequency used by the A-IoT device may be denoted as ‘fu’. The A-IoT device may receive query commands transmitted by the reader apparatus (e.g., a UE reader or a gNB) through the UL frequency. According to the commands, the A-IoT device may use a backscatter communication method to reflect the received signal back on the same UL frequency ‘fu’. The backscatter communication method may allow the A-IoT device to communicate by modulating the reflected signal. Therefore, the requirement for the active signal transmission may be reduced and the power consumption may also be reduced.

Referring to FIG. 10, in order to reduce the intra-cell interference between the A-IoT signal and the physical uplink shared channel (PUSCH) used by other UEs within the frequency spectrum for UL communication, the A-IoT GBs may be configured in the frequency spectrum for UL communication. The A-IoT GBs may be configured between the A-IoT signal and the PUSCH to prevent the interference from the subcarriers in neighboring frequency. The network node may configure the size of the A-IoT GB. The network node may determine the size of the A-IoT GB from zero to two REs. In addition, the network node may transmit the configuration of the A-IoT GB to the A-IoT device and the UE reader through the SI broadcasts or the RRC messages to ensure that the A-IoT device and the UE reader can be synchronized in the spectrum and preserve the clarity and integrity of the A-IoT communication.

FIG. 11 illustrates an example scenario 1100 for a guard band frequency configuration in a frequency spectrum for UL communication in accordance with implementations of the present disclosure. Scenario 1100 involves an A-IoT device and a reader apparatus (e.g., a network node or a UE). Referring to FIG. 11, the A-IoT device may use the guard band frequency (e.g., the guard bands within the NR UL frequency spectrum). The UL NR guard bands (NR GBs) may be configured on both sides of the channel bandwidth (e.g., 10 MHz or 20 MHZ) to reduce the inter-cell interference. Within the guard band frequency, the reader apparatus (e.g., a UE reader or a gNB) may broadcast a query command through an UL frequency (or A-IoT frequency) which is labeled as ‘fug’. The UL frequency in the guard band frequency may be configured to the A-IoT device for communications to avoid the interference with the main UL traffic channels.

Referring to FIG. 11, in order to provide an additional protection and reduce the interference from the signals in adjacent cells, the A-IoT GBs may be configured on both sides of the A-IoT frequency ‘fug’. The A-IoT GBs may be configured in a clear separation between the A-IoT communications and the regular UL traffic of neighboring cells. The network node may configure the A-IoT GBs to extend from zero to six REs according to the requirements of the A-IoT deployment. The configuration of the A-IoT GBs may be transmitted to the A-IoT device and the UE reader through the SI broadcasts or the RRC messages to ensure that the A-IoT device and the UE reader can operate according to the network-defined parameters to maintain the robust and interference-free A-IoT communications.

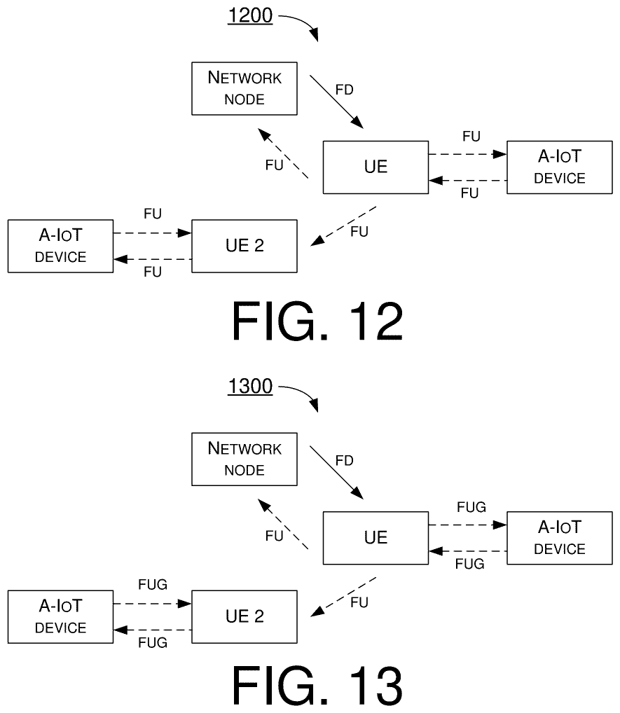

FIG. 12 illustrates an example scenario 1200 for an A-IoT communication architecture in accordance with implementations of the present disclosure. Scenario 1200 involves at least one reader apparatus (e.g., UE and UE 2), at least one A-IoT device and a network node (e.g., a (macro/micro) base station) which may be a part of a wireless network (e.g., an LTE network, a 5G/NR network, an IoT network or a 6G network). Referring to FIG. 12, the A-IoT devices may operate within the UL frequency of a frequency division duplexing (FDD) network. As shown in FIG. 12, a UE reader may transmit a query command to an A-IoT device through the UL frequency which is denoted as ‘fu’. The A-IoT device supporting the backscattering on the UL transmission may reflect the signal back to the UE reader without the frequency shift. That is, the A-IoT device can only use the same UL frequency ‘fu’ for both the reception and the transmission of the backscattered signal.

In the normal FDD networks, the UE readers may receive signals only on the DL frequency, not on the UL frequency. Therefore, when the UE reader transmits a query on the UL frequency ‘fu,’ the UE reader may also need the capability of receiving the backscattered response from the A-IoT device on the same UL frequency ‘fu’. As a result, a potential interference may occur. For example, when the UL frequency is congested with other signals from different devices, the reception of the A-IoT response signal may be interrupted.

In order to resolve the above mentioned issue, the UE reader may monitor the specific occasions on the UL frequency ‘fu’ to receive the response of the A-IoT device. The occasions may be predefined by the network node. The network node may transmit the information of the occasions to the UE reader via the RRC or SI messages. In addition, the network node may use a timing advance (TA) mechanism to synchronize the UL transmissions of all UE readers and A-IoT devices to ensure that the network node can receive the UL transmissions in a coordinated manner. The TA values (e.g., an absolute value or a delta value) may indicate the timing adjustment needed for the response of A-IoT device to ensure the UL transmissions arrive at the network node precisely may be aligned with the timing grid of the network node. The absolute TA values may be adjusted based on the DL reception timing, and the delta TA values may be adjusted based on the timing of the previous UL transmission. The network node may provide the TA values to the UE reader within the query command or an acknowledgment (ACK). After receiving the query command, the tag may generate a 16-bit random number (RN16) and sends it back to the reader. The network node may also transmit the TA values to the A-IoT device through the medium-access-control control-elements (MAC CE) or the RRC messages. The above proposed solution may ensure that the UL backscatter transmissions of the A-IoT device can be accurately performed to avoid the interference and maintain the integrity of the communication link.

FIG. 13 illustrates another example scenario 1300 for an A-IoT communication architecture in accordance with implementations of the present disclosure. Scenario 1300 involves at least one reader apparatus (e.g., UE and UE 2), at least one A-IoT device and a network node (e.g., a (macro/micro) base station) which may be a part of a wireless network (e.g., an LTE network, a 5G/NR network, an IoT network or a 6G network). Referring to FIG. 13, a frequency band (e.g., a dedicated sub-1 GHz band or a specifically designated guard band) used in the UL spectrum or the DL spectrum may be referred to as ‘fug’ and ‘fdg’ respectively. The frequency bands ‘fug’ and ‘fdg’ may be used for A-IoT communications to prevent any overlap with the frequency bands used by the network node. Therefore, the risk of interference may be eliminated.

The network node may configure the time and frequency domain resources for the dual-way communication between the UE reader and the A-IoT device. The network node may transmit the configurations to the UE reader through the RRC or SI messages. The frequency domain resources may be specifically assigned as the dedicated A-IoT bands, UL guard bands, or DL guard bands according to the strategy for A-IoT integration. For the UL guard band ‘fug,’ the transmission timing for A-IoT communication may be synchronized with the UL timing of the UE reader. The network node may manage these timing through the TA MAC CEs. The UE reader may provide one or multiple UL timing resources to the A-IoT device. Then, the A-IoT device may select the most appropriate timing resource(s) to respond within the UL guard band ‘fug’. Similarly, for the DL guard band ‘fdg,’ the transmission timing of the A-IoT device may be aligned (or synchronized) with the DL timing of the UE reader through the synchronization signal block (SSB) and the channel state information-reference signals (CSI-RS). The UE reader may also provide various UL timing resources for A-IoT communication to the A-IoT device. Then, the A-IoT device may choose the most appropriate timing resource(s) to respond within the DL guard band ‘fdg’. The solution of FIG. 13 may ensure that the A-IoT devices can operate within the exist network without impacting the existing cellular infrastructure and maintaining clear and interference-free communication channels.

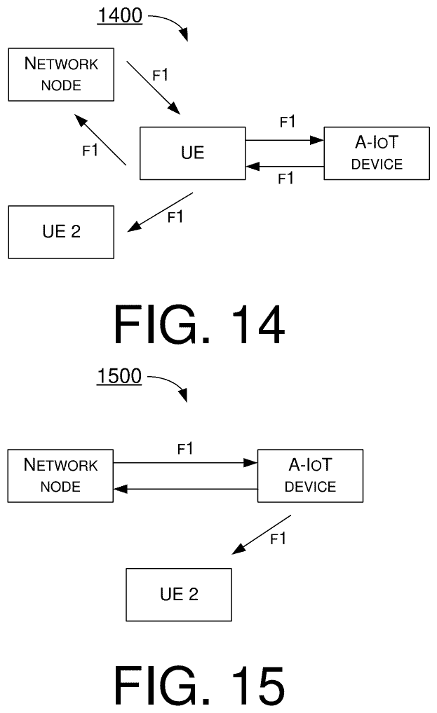

FIG. 14 illustrates another example scenario 1400 for an A-IoT communication architecture in accordance with implementations of the present disclosure. Scenario 1400 involves at least one reader apparatus (e.g., UE and UE 2), at least one A-IoT device and a network node (e.g., a (macro/micro) base station) which may be a part of a wireless network (e.g., an LTE network, a 5G/NR network, an IoT network or a 6G network). Referring to FIG. 14, A-IoT communications may be applied in an FFD network (or an FDD spectrum). As shown in FIG. 14, a DL frequency (or a DL spectrum) used in the FDD spectrum may be denoted as ‘f1’. In the FDD spectrum, the UE reader may be configured to monitor the DL frequency ‘f1’ for its DL signals. However, if the UE reader broadcasts a query command on the DL frequency ‘f1,’ the broadcast may be potentially interfered by the DL reception of another UE reader. In order to mitigate the interference, the network node may allocate the UE-specific DL resources to the UE reader e.g., the dynamic PDSCH resources, the semi-persistent scheduling (SPS) DL resources, or a measurement gap.

The PDSCH resource may be allocated dynamically based on the range from 4 to 12 OFDM symbols. The SPS resources may be configured with the periodicities ranging from 10 ms to 640 ms for scheduling the PDSCH flexibly. The measurement gap may provide a specific duration. During the measurement gap, the UE reader can monitor other frequencies without missing its own DL transmissions. In order to ensure that the certain time domain resources on the DL frequency ‘f1’ are dedicated to a specific UE, the network node may prevent other UE reader (e.g., UE 2) from monitoring the same time/frequency (T/F) resources. Therefore, the interference between different UE readers and the interference between the UE and the A-IoT device can be reduced.

Even if the DL frequency ‘f1 is used for the A-IoT communication, the UE reader or the network node may still need to manage the UL timing of the backscattered response of the A-IoT device. The network node may transmit the TA commands to the UE reader to control the timing of the UL transmission of the A-IoT device to ensure the synchronization with the network node. Similarly, the UE reader may transmit the TA commands within the query or acknowledgment (ACK) commands to indicate the timing of the A-IoT device. It should be noted that note that when the network node allocate the T/F resources on the DL frequency ‘f1’ for the A-IoT communication, the network node may refrain from transmitting any other signals on the allocated resources. In addition, the UE reader may not receive any signals except for the A-IoT communication signals on the allocated T/F resources to ensure that a clear and dedicated channel is allocated for the A-IoT operations.

FIG. 15 illustrates another example scenario 1500 for an A-IoT communication architecture in accordance with implementations of the present disclosure. Scenario 1500 involves a reader apparatus, an A-IoT device and a network node (e.g., a (macro/micro) base station) which may be a part of a wireless network (e.g., an LTE network, a 5G/NR network, an IoT network or a 6G network). Referring to FIG. 15, a DL frequency (or a DL spectrum) may be used to perform the communication between A-IoT devices and the network node. The DL frequency may be identified as ‘f1’. The network node may communicate with the A-IoT device through the T/F resources on the frequency ‘f1’ which may not concurrently allocated to other UE readers (e.g., UE 2). The method may ensure that there is no interference from the DL receptions of other UE readers within the communication network. The existing DL NR signals or channels (e.g., the PDSCH, the SPS DL, and the measurement gap configurations) can be reused for the A-IoT communications without disruption.

However, a potential challenge may occur when the A-IoT device performs the backscattering through the DL frequency ‘f1’. The network node may need to ensure that the UL timing of the backscattered signal from the A-IoT device may not cause interference with other UE readers in the communication network. The network node may not have precise location information for all UE readers. As a result, the timing conflicts may need to be prevented. Therefore, the network node may use the TA commands to control the UL timing of the A-IoT devices. In addition, the network node may reserve the guard bands (or guard times) which may be expressed in the units of microseconds or OFDM symbols. No signal can be transmitted during the guard bands (i.e., the empty signal periods) to prevent the interference.

The network node may transmit the information of the guard bands and TA commands to the A-IoT devices to ensure that the timing of the backscattered UL transmissions does not overlap with the DL reception times of other UE readers in the same cell. By signaling or configuring the information (or parameters) to the A-IoT devices, the network node may effectively coordinate the T/F resources to maintain a harmonious communication environment. Therefore, all UE readers including the UE which is not involved the A-IoT communication may not interfere by the A-IoT signals which are transmitted through backscattering transmission on the DL frequency ‘f1’.

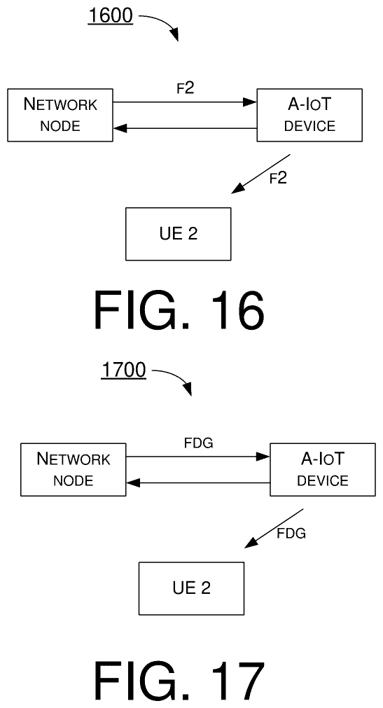

FIG. 16 illustrates another example scenario 1600 for an A-IoT communication architecture in accordance with implementations of the present disclosure. Scenario 1600 involves at least one reader apparatus, at least one A-IoT device and a network node (e.g., a (macro/micro) base station) which may be a part of a wireless network (e.g., an LTE network, a 5G/NR network, an IoT network or a 6G network). Referring to FIG. 16, a UL frequency (or a UL spectrum) used for the communication between the network node and the A-IoT device may be referred to as ‘f2’. As shown in FIG. 16, the network node may allocate the T/F resources on the UL frequency ‘f2’ for the communication between the network node and the A-IoT device to ensure that the resources may not simultaneously used by other UE readers (e.g., UE2). Therefore, the network node may effectively prevent the interference with the UL transmissions of other UE readers within the communication network. The existing UL NR signals or channels (e.g., the PUSCH or the configured grant (CG) UL) can be reused for the A-IoT communications.

However, a potential challenge may occur when the network node need to listen to signals and transmit signals on the UL spectrum ‘f2’ at the same time. Therefore, the guard bands (guard times) may be required. During the guard band, the network node may not listen to the UL transmissions from the UE readers on the T/F resources which are allocated for the A-IoT communication on the UL frequency ‘f2’ to ensure that there is no overlap between the A-IoT communication and the regular UL traffic from other UE readers.

The network node may transmit the information of the specific durations reserved for the A-IoT communication to all UE readers through the SI broadcasts. In addition, the UL timing for the A-IoT devices may be configured through the TA commands from the network node. The TA commands may be used to synchronize the UL transmissions of the A-IoT device with the timing of the network node to ensure that the A-IoT signals do not interfere with the UL transmissions of other UE readers. By controlling the UL timing through TA commands and broadcasting the reserved communication durations, the network node may effectively coordinate the UL frequency ‘f2’ to perform an interference-free communication between the network node and the A-IoT devices and to maintain the integrity of the UL transmissions for the UE readers in the communication network.

FIG. 17 illustrates another example scenario 1700 for an A-IoT communication architecture in accordance with implementations of the present disclosure. Scenario 1700 involves at least one reader apparatus, at least one A-IoT device and a network node (e.g., a (macro/micro) base station) which may be a part of a wireless network (e.g., an LTE network, a 5G/NR network, an IoT network or a 6G network). Referring to FIG. 17, the A-IoT device may use a frequency band. The frequency band may be a dedicated sub-1 GHz frequency or a guard band frequency for the UL and/or the DL. The guard band frequency for the UL and the DL may be labeled as ‘fug’ and ‘fdg’ respectively. The guard band frequency may be used to ensure that the A-IoT communications may not interfere with the transmissions of normal operations of the UEs and the network nodes.

In the UL guard band frequency ‘fug’ or the DL guard band frequency ‘fdg,’ the network node may control the transmission timing for the A-IoT communications through the timing advance commands (TACs). The TACs may be used for the synchronization between the transmissions of the A-IoT device with the timing grid of the network node. Therefore, the potential timing conflicts with other network operations can be avoided.

For the DL guard band frequency ‘fdg’, the transmission timing of the A-IoT device may be aligned with the DL timing of the UE reader to ensure that the transmission of the UE reader may not be interfered by the backscattered DL signal of the A-IoT device when the UE reader receives the DL transmissions from the network node. By managing the timing with the TAC, the network node may coordinate the A-IoT communications within the guard band frequency. Therefore, the A-IoT devices can be applied to the existing communication network structure without affecting the performance or reliability of the legacy UE communications.

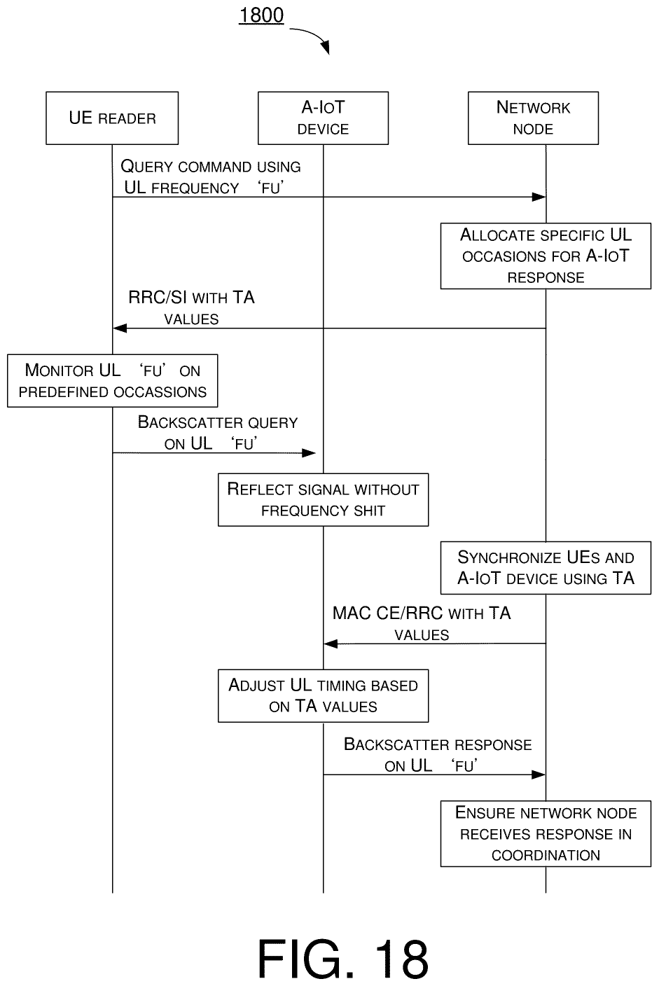

FIG. 18 illustrates an example scenario 1800 for a communication process within an FDD network in accordance with implementations of the present disclosure. Scenario 1800 involves at least one reader apparatus (e.g., UE or UE reader), at least one A-IoT device and a network node (e.g., a (macro/micro) base station) which may be a part of a wireless network (e.g., an LTE network, a 5G/NR network, an IoT network or a 6G network). Referring to FIG. 18, the UE reader may transmit a query command to the A-IoT device and the network node through the UL frequency ‘fu’. When the network node receives this query command, the network node may identify the specific UL occasions for the UE reader to await the response of the A-IoT device. The scheduling information comprising the TA values may be transmitted to the UE reader via the RRC or SI messages. The UE reader may monitor UL frequency ‘fu’ on predefined occasion and backscatter the query command to the A-IoT device through the UL frequency ‘fu’.

In response to the query command, the A-IoT device may backscatter the signal using the same UL frequency ‘fu’, to reflect the signal with no alteration in frequency (i.e., without frequency shift). In order to ensure synchronization across the communication network, the network node may coordinate the timing of all UE readers and the A-IoT device by using the TA mechanism. The network node may transmit the MAC CE or RRC messages to the A-IoT device. The MAC CE or RRC messages may comprise the necessary TA values. The A-IoT device may adjust its UL transmission timing according to these TA values to guarantee that its backscattered response is precisely synchronized. The A-IoT device may backscatter the response on the UL frequency ‘fu’. Therefore, the network node can receive the response in coordination with the rest of the network traffic. The communication process illustrated in FIG. 18 may preserve the integrity of the communication link among the UE reader, the A-IoT device, and the network node.

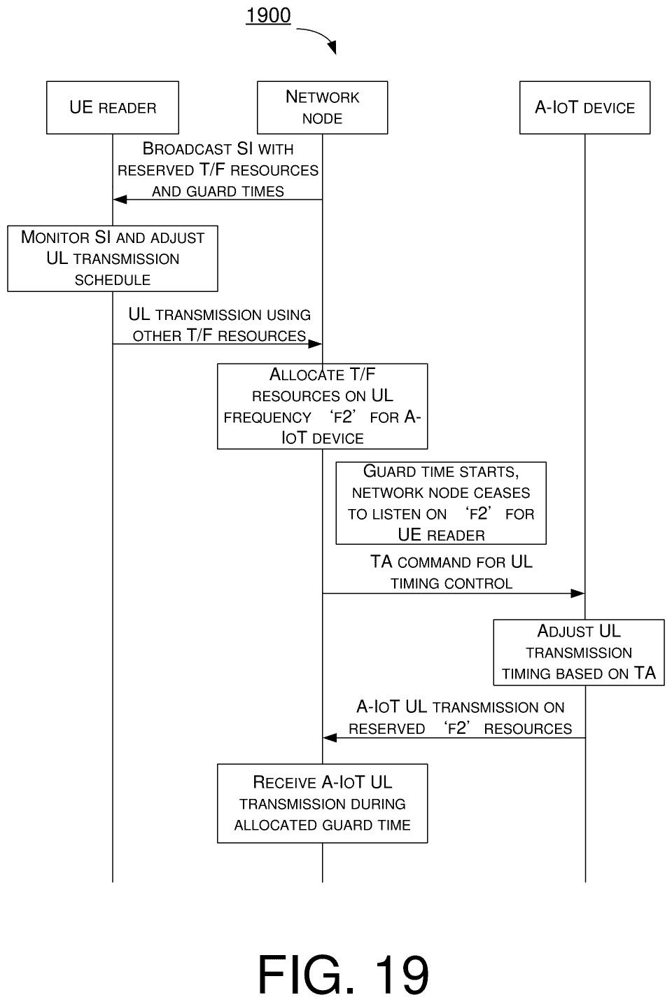

FIG. 19 illustrates another example scenario 1900 for a communication process within an FDD network in accordance with implementations of the present disclosure. Scenario 1900 involves at least one reader apparatus (e.g., UE or UE reader), at least one A-IoT device and a network node (e.g., a (macro/micro) base station) which may be a part of a wireless network (e.g., an LTE network, a 5G/NR network, an IoT network or a 6G network). Referring to FIG. 19, the UE reader, the A-IoT device, and the network node may use the UL spectrum ‘f2’ in the FDD network. The network node may initiate the communication process by broadcasting the SI which comprises the reserved time/frequency (T/F) resources and the guard times (or guard bands) for A-IoT communications. The UE reader may monitor the SI and adjust the UL transmission scheduling to avoid interference from the reserved T/F resources.

During the guard times indicated in the SI, the network node may stop listening to UL transmissions from UE reader on the UL frequency ‘f2’. The network node may only focus on the A-IoT communications during the guard times. The network node may transmit TA commands to the A-IoT device to precisely control its UL transmission timing to ensure that the transmission of the A-IoT device does not interfere with the communications of the UE reader. When the guard time starts, network node may cease to listen on ‘f2’ for UE reader. The A-IoT device may transmit its UL signal on the UL frequency ‘f2’ resources during the allocated guard time, and the network node may receive the UL signal from the A-IoT device without any interference from the UE reader. The network node may perform UL transmission using other T/F resources during the allocated guard time with the UE reader.

The communication process illustrated in FIG. 19 may maintain an interference-free communication environment on the UL frequency ‘f2,’ to ensure the integrity of the transmissions of the A-IoT device and the UE reader within the communication network.

The half-duplex (HDX) radio frequency identification (RFID) systems which are operated in the time-sharing communication between the reader (e.g., the reader apparatus) and the tag (e.g., the IoT device) may offer a simpler reader design and a longer read range (e.g., 2×) over the full-duplex (FDX) systems. However, the FDX systems allow the simultaneous two-way communication. Therefore, more complex readers may be needed to discriminate the response of the tag from background noise.

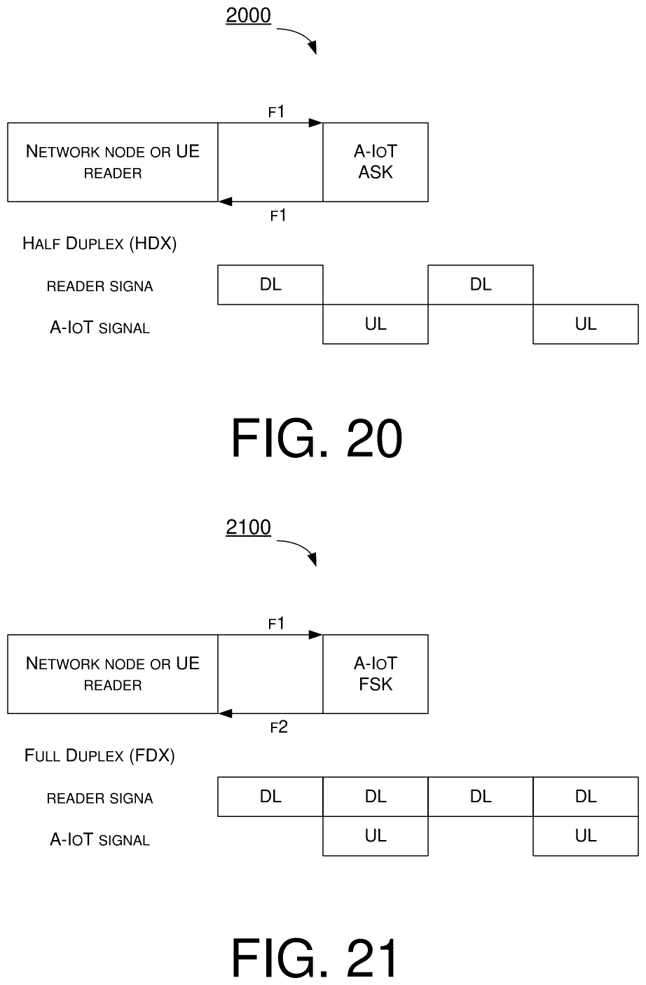

FIG. 20 illustrates an example scenario 2000 for a transmission in an HDX system in accordance with implementations of the present disclosure. Scenario 2000 involves an A-IoT device and a reader apparatus (e.g., a network node or a UE). Referring to FIG. 20, the operation of a HDX system applied in an A-IoT communication is illustrated. As shown in FIG. 20, according to the time-sharing communication protocol of the HDX mode, the A-IoT device (or tag) may be charged by an electromagnetic field generated by the reader apparatus. The reader apparatus may comprise a network node (e.g., a gNB), a reader, or a separate energy source. The reader apparatus may generate an alternating current (AC) field which is provided to the A-IoT device to charge its internal capacitor.

When the A-IoT device has obtained enough power, the reader apparatus may transmit commands by modulating the powering field. After the reader apparatus may transmit the commands to the A-IoT device, the reader apparatus may stop emitting the field and switch to a receptive state to wait the response the A-IoT device. Then, the A-IoT device may use the energy stored in its capacitor to backscatter a response to the reader apparatus. The reader apparatus may process the response. The HDX system has the non-simultaneous exchange characteristic. Therefore, the reader apparatus and the A-IoT device may be switched between transmitting and receiving modes.

It should be noted that the implementations of the present disclosure should not be limited to the HDX. The communication system of the present disclosure may be capable of supporting both the HDX mode and the FDX mode.

FIG. 21 illustrates an example scenario 2100 for a transmission in an FDX system in accordance with implementations of the present disclosure. Scenario 2100 involves an A-IoT device and a reader apparatus (e.g., a network node or a UE). Referring to FIG. 21, the operation of an FDX system applied in an A-IoT communication is illustrated. As shown in FIG. 21, in the FDX communication system, the A-IoT device (or the tag) may be capable of receiving power and commands from the reader apparatus and transmitting the response to the reader apparatus accordingly. The reader apparatus may comprise a network node (e.g., a gNB), a UE reader, or an independent power source. The reader apparatus may emit a continuous AC magnetic field which is used to provide power to the A-IoT device and carry the modulated commands to the A-IoT device.

In the FDX mode, the A-IoT device may respond by superimposing its own signal onto the carrier frequency through frequency shift keying (FSK) modulation. The simultaneous transmission and reception may enable a continuous exchange of information between the reader apparatus and the A-IoT device. The role of the reader apparatus in an FDX system is complex. The reader apparatus may involve maintaining the powering field, modulating commands into the field, and simultaneously demodulating the superimposed response of the A-IoT device. The circuitry of the reader apparatus may need to separate the response of the A-IoT device from the carrier signal and any external noise which may be present in the environment.

As shown in FIG. 21, the advantage of the FDX system is that it can achieve faster data transfer rates because of the simultaneous two-way communication capability. However, the FDX system may need to have complexity design for the reader apparatus. The reader apparatus may need to have the filtering mechanisms to ensure the integrity of the communication process. Even if the complexity design for the reader apparatus is required, the FDX systems are still valuable in the scenarios where speed and efficiency are required.

It should be noted that the implementations of the present disclosure should not be limited to the FDX. The communication system of the present disclosure may be capable of supporting both the HDX mode and the FDX mode.

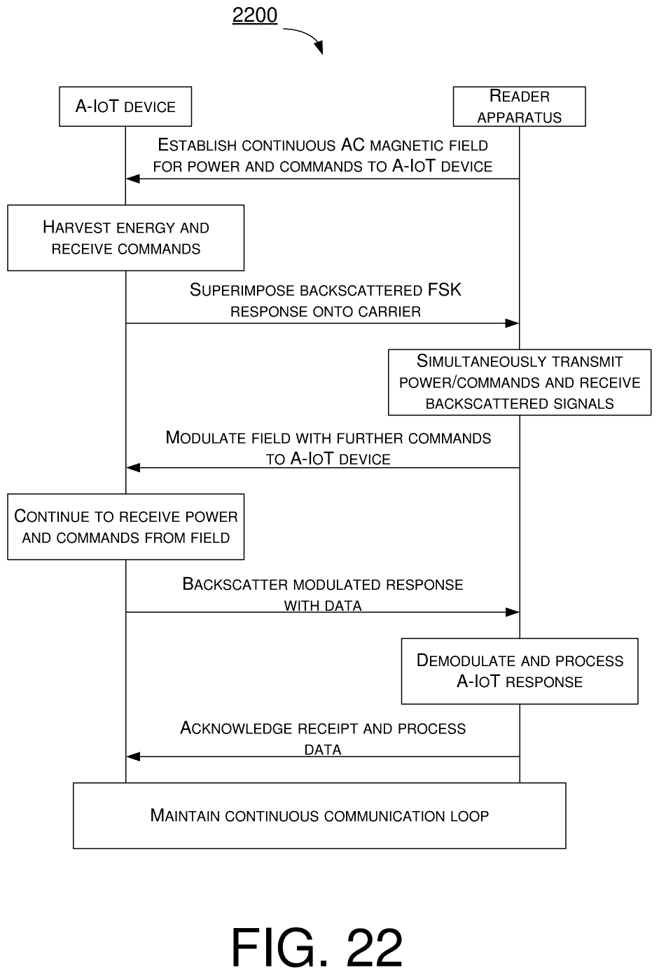

FIG. 22 illustrates an example scenario 2200 for a communication process in accordance with implementations of the present disclosure. Scenario 2200 involves an A-IoT device and a reader apparatus (e.g., a network node or a UE). As shown in FIG. 22, the reader apparatus (e.g., the UE reader or the network node) may establish a continuous AC magnetic field. The AC magnetic field may be used to provide power to the A-IoT device and carry the modulated commands.

The A-IoT device may harvest (or obtain) the energy and receive the commands from the reader apparatus. Then, the A-IoT device may backscatter an FSK modulated response onto the carrier signal. The A-IoT device may superimpose backscattered FSK response onto the carrier. The reader apparatus may transmit the power and commands to the A-IoT device and receive the backscattered signal from the A-IoT device simultaneously.

The reader apparatus may continuously modulate the AC magnetic field with the commands, and the A-IoT device may continuously respond with the backscattered modulated data. The reader apparatus may demodulate and process the response from the A-IoT device and acknowledge (or confirm) the reception data to maintain a continuous communication loop. As shown in the communication process of FIG. 22, the full-duplex communication may be performed to achieve the efficient and uninterrupted data exchange between the A-IoT device and the reader apparatus.

When the FDD is applied to both UL transmission and DL transmission of the UE reader, the UE reader may need an additional receiver for the UL spectrum. The requirement may increase the complexity and cost of the UE design.

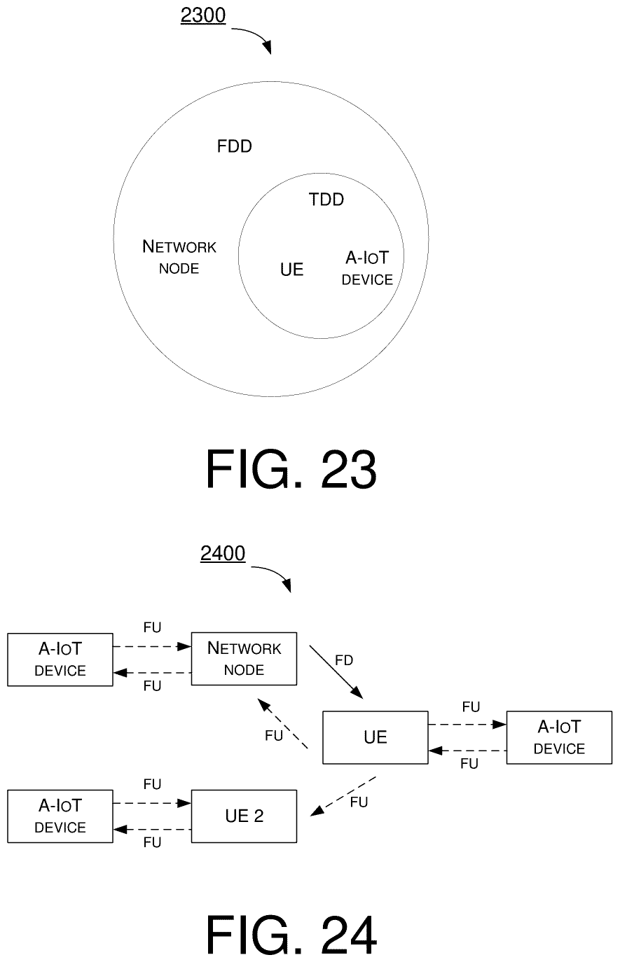

FIG. 23 illustrates an example scenario 2300 for a heterogeneous network deployment in accordance with implementations of the present disclosure. Scenario 2300 involves at least one reader apparatus (e.g., UE or UE reader), at least one A-IoT device and a network node (e.g., a (macro/micro) base station) which may be a part of a wireless network (e.g., an LTE network, a 5G/NR network, an IoT network or a 6G network). Referring to FIG. 23, the heterogeneous network deployment may integrate a large FDD cell with a macro base station and a smaller TDD cell with a micro base station. In the deployment, the UE reader may aggregate the FDD and TDD bands to establish robust connections with the network node and the A-IoT device. The FDD band (e.g., sub-1 GHz frequencies) may be used for the link between the network node and the UE reader to capitalize on the superior coverage characteristics of lower frequencies. The TDD band may be used for the link between the UE reader and the A-IoT device to simplify the design of the UE reader, i.e., the UE reader may not need additional UL receiver.

In the heterogeneous network deployment, the UE reader may dynamically select the optimal communication band to maintain the service continuity and the network efficiency. The macro base station and the micro base station may coordinate the interference management between the FDD and TDD cells. The UE reader may adjust its transmission power for TDD communication with the A-IoT device according to the power control commands from the network node to ensure the minimal interference and the optimal signal strength. The synchronization between the UE reader and the network node may be maintained to align with the UL/DL configuration of the TDD cells to prevent the signal collision and the interference. Furthermore, the UE may be configured to handover between the FDD and TDD cells to ensure uninterrupted service.

FIG. 24 illustrates an example scenario 2400 for a network deployment scenario in accordance with implementations of the present disclosure. Scenario 2400 involves at least one reader apparatus (e.g., UE or UE reader), at least one A-IoT device and a network node (e.g., a (macro/micro) base station) which may be a part of a wireless network (e.g., an LTE network, a 5G/NR network, an IoT network or a 6G network). Referring to FIG. 24, the network node may manage the allocation of time and frequency resources and the UL timing and power to reduce the interference among the UE readers, the network node, and the A-IoT devices. The UE reader may receive commands from the network node to regulate the UL power and the timing of the A-IoT devices to achieve an orderly and efficient network environment.

As shown in FIG. 24, the network node may configure the resource allocation, the frequency bands, the time slots, and the power levels to the UE reader and the A-IoT devices for UL and DL communications. The UE reader may be designed to be backward compatible, functioning seamlessly with both contemporary and legacy systems across different network environments. The receiver within the UE reader may be designed to control the operations of the mixed FDD/TDD network without an additional UL receiver. Centralized control of the network node may ensure that the UL power and the timing of the A-IoT devices are precisely managed to optimize the network performance and reduce the interference. In addition, the UE reader may be regarded as an intermediary to transmit the information between the network node and A-IoT devices to achieve the coordinated management and control within the communication network.

The above implementations for operations among the UE readers, A-IoT devices, and network node within the communication network may a seamless combination of FDD and TDD benefits to ensure the efficient communication and resource utilization within a heterogeneous network framework.

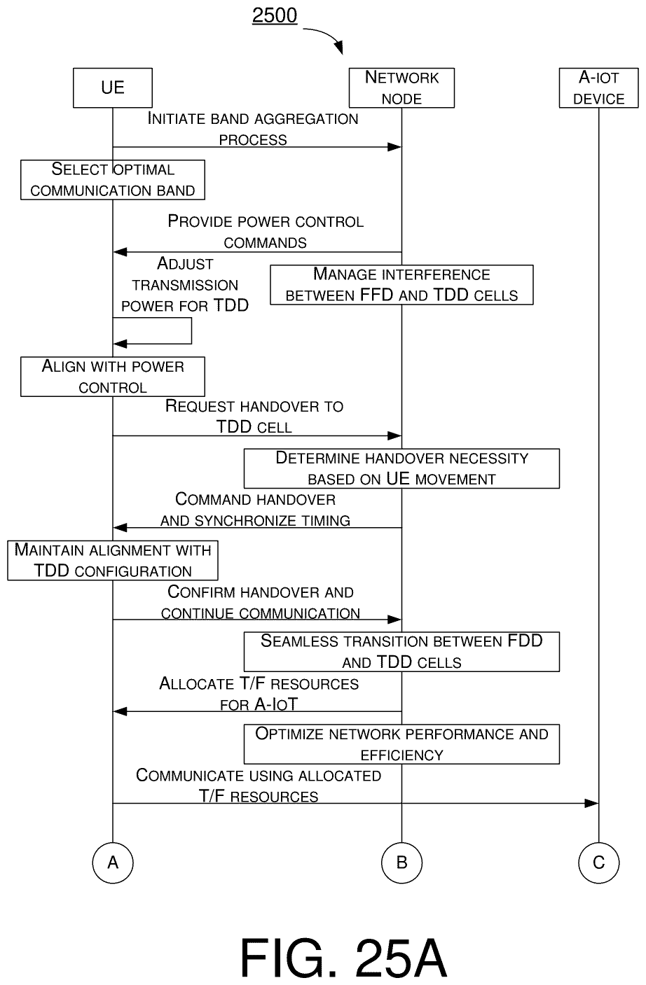

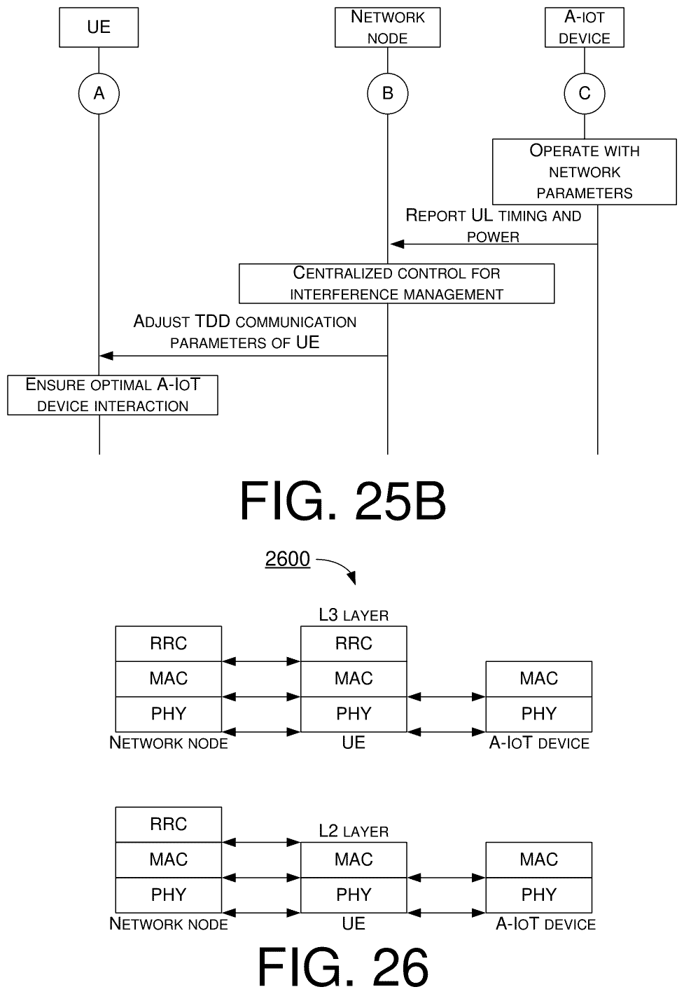

FIGS. 25A-25B illustrate an example scenario 2500 for a band aggregation process in accordance with implementations of the present disclosure. Scenario 2500 involves at least one reader apparatus (e.g., UE or UE reader), at least one A-IoT device and a network node (e.g., a (macro/micro) base station) which may be a part of a wireless network (e.g., an LTE network, a 5G/NR network, an IoT network or a 6G network). Referring to FIGS. 25A-25B, the UE reader may initiate the band aggregation process to establish the robust connections with the network node and the A-IoT device. The UE reader may select optimal communication band. The network node may transmit the power control commands to manage the interference and ensure the optimal signal strength. The UE reader may adjust its transmission power for the TDD communication to align with power control. The UE reader may request a handover to a TDD cell. The network node may determine handover necessity based on the movement of UE reader. The network node may indicate (or command) the handover and synchronize the timing to prevent the signal collision and interference.

When the UE reader confirms the handover, the UE reader may perform the communication within the TDD cell continuously. The network node may perform seamless transition between FDD and TDD cells. The network node may allocate the time and frequency resources for the A-IoT devices, to optimize the network performance. The UE reader may communicate with the A-IoT device according to the allocated resources. The A-IoT device may operate with parameters configured by network/UE reader. The A-IoT device may report the UL timing and power to the network node for the centralized control for the interference management. Finally, the network node may adjust the TDD communication parameters of the UE reader to ensure the efficient interaction with A-IoT devices.

The band aggregation process may provide a clear and structured representation of the signaling and behavior of the UE reader and network node within a heterogeneous network which use both of the FDD and TDD technologies.

The A-IoT devices may be capable of backscattering signals to communicate directly with a network node. However, when the A-IoT devices are located indoors, the backscattering to the network node may not be applicable.

FIG. 26 illustrates an example scenario 2600 for a UE reader configuration for different communication layers in accordance with implementations of the present disclosure. Scenario 2600 involves a reader apparatus (e.g., UE or UE reader), an A-IoT device and a network node (e.g., a (macro/micro) base station) which may be a part of a wireless network (e.g., an LTE network, a 5G/NR network, an IoT network or a 6G network). Referring to FIG. 26, the UE reader may be configured to operate as a relay in two different communication layers: a Layer 3 (L3) relay and a Layer 2 (L2) relay. The UE reader may comprise a plurality of communication layers to perform the bidirectional communication with the network node and the A-IoT devices.

According to a first implementation of the UE reader being an L3 relay, the UE reader may comprise an RRC layer, an MAC layer, and a physical (PHY) layer. The RRC layer may be configured to manage the high-level protocol functions, e.g., the connection establishment, maintenance, and mobility management between the UE reader and the network node, but the disclosure should not be limited thereto. The MAC layer and PHY layer may be used for performing communication with the A-IoT device. The A-IoT device may comprise corresponding MAC layer and PHY layer but does not comprise an RRC layer. The UE reader may perform the DL and UL transmissions with the network node to playing an intermediary for relaying information between the network node and the A-IoT devices.

According to a second implementation of the UE reader being an L2 relay, the UE reader may comprise only the MAC layer and PHY layer for communication. The configuration may simplify the relay role of the UE reader and focus on the data link and physical transmission of the communication. The network node may transmit the commands to the A-IoT devices through the UE reader. That is, the UE reader may receive the commands from the network node and transmit the commands to the A-IoT devices through the MAC layer and PHY layer. The communication between the UE reader and the network node may also be performed through the MAC layer and PHY layer without the intervention of the higher-layer processing.

The UE reader in both implementations may be regarded as a relay for communication between the network node and the A-IoT devices. The difference between the two relay implementations are the communication layers used by the UE reader for communication. In the L3 relay implementation, the UE reader may handle more complex interactions with the network node. In the L2 relay implementation, the UE reader may focus on the data link layer functions (e.g., the framing and error detection) and the physical layer functions (e.g., the signal transmission and reception).

The different implementations of the UE reader within a communication network may be selected according to the communication requirements and the capabilities of the A-IoT devices. The adaptability may ensure the efficient utilization of the network resources and the compatibility with A-IoT devices of varying communication stack complexities.

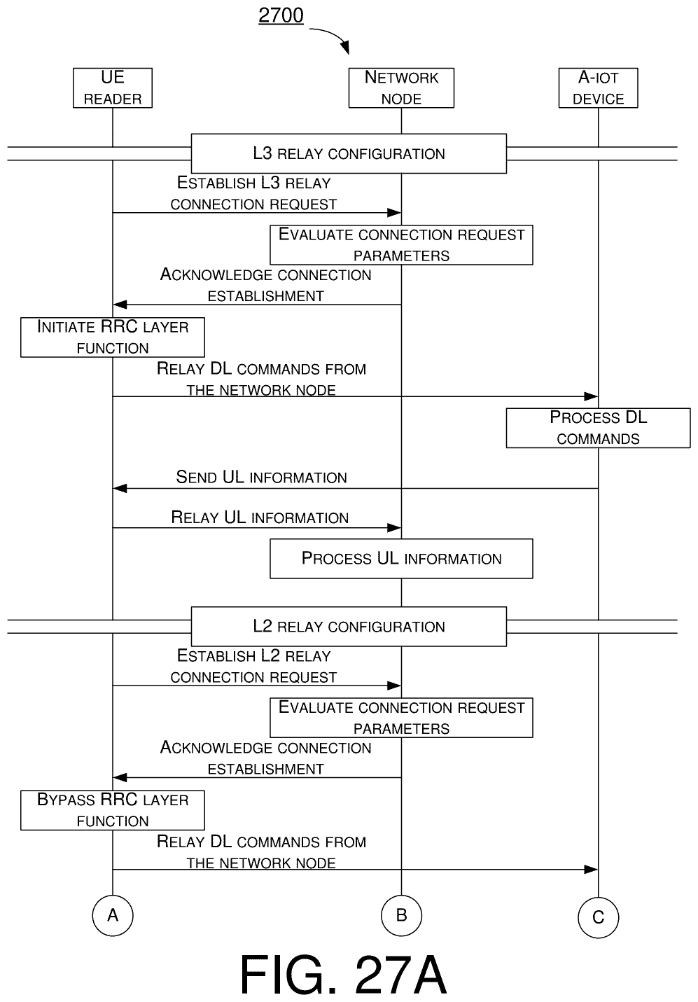

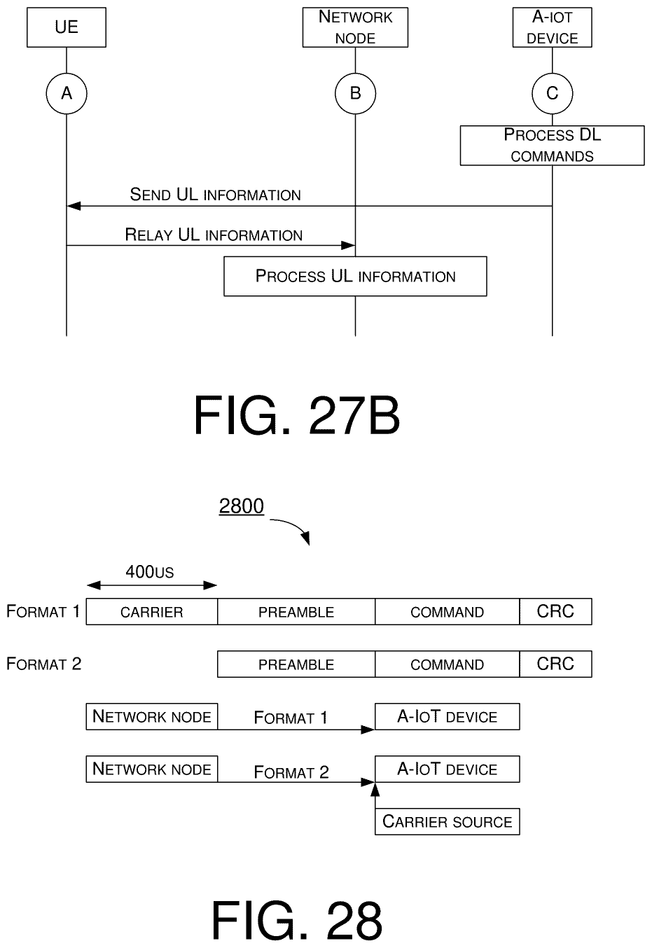

FIGS. 27A-27B illustrates an example scenario 2700 for a communication process for different communication layers in accordance with implementations of the present disclosure. Scenario 2700 involves at least one reader apparatus (e.g., UE or UE reader), at least one A-IoT device and a network node (e.g., a (macro/micro) base station) which may be a part of a wireless network (e.g., an LTE network, a 5G/NR network, an IoT network or a 6G network). Referring to FIGS. 27A-27B, the sequence of messages exchanged among the UE reader, the network node, and the A-IoT devices under both L3 and L2 relay configurations are illustrated. The UE reader may be regarded as a relay. The UE reader may adaptively select the operational mode (e.g., the L2 relay configuration or the L3 relay configuration) according to the requirements of the network and the capabilities of the A-IoT devices. As shown in FIGS. 27A-27B, the interactions and processes of the communication process may enable the UE reader to perform efficient and compatible communication within the A-IoT communication system. The UE reader may transmit an L3 relay connection request for establishing an L3 relay connection to the network node. The network node may evaluate the parameters of the connection request and send back the connection establishment Acknowledge to the UE reader. Then the UE reader may initiate an RRC layer function. The UE reader may relay DL commands from the network node to the A-IoT device. A-IoT device may process DL commands and send UL information to the UE reader. The UE reader may relay UL information to the network node for performing efficient and compatible communication within the A-IoT communication system. For the L2 relay configurations, the UE reader may transmit a L2 relay connection request for establishing a L2 relay connection to the network node. In addition, the UE reader may bypass the RRC layer function after receiving the connection establishment Acknowledge, except for performing operations similar to the L3 relay configuration mentioned above.

It may be unclear how the A-IoT devices harvest energy. A continuous waveform or a carrier waveform (CW) before the preamble for better power accumulation may be necessary to optimize device activation and ensure consistent operation within the A-IoT communication system.

FIG. 28 illustrates an example scenario 2800 for different communication formats in accordance with implementations of the present disclosure. Scenario 2800 involves an A-IoT device and a reader apparatus (e.g., a network node or a UE). As shown in FIG. 28, two types of communication formats for the communication between the reader apparatus (e.g., network node or UE reader) and the A-IoT device are illustrated. In an example, the reader apparatus may use the communication format 1 to provide energy and message to the A-IoT device. In another example, the reader apparatus may use the communication format 2 to provide message to the A-IoT device and another carrier source may provide the carrier waveform to the A-IoT device for charging. The reader apparatus and the carrier source may be controlled by the network node to prevent interference. For example, the carrier source may use the UL frequency (or the UL spectrum) to broadcast the carrier waveform within the configured T/F resources from the network node.

The communication format 1 may be a comprehensive communication structure. The communication format 1 may comprise four components: a carrier, a preamble, a command, and a CRC. In an example, the carrier may comprise a duration of 400 microseconds (us) to serve as an energy source. The A-IoT device may harvest (or obtain) the necessary power from the carrier for activation. The preamble may follow the carrier. The A-IoT devices may use the preamble for synchronization. The command may comprise the broadcast query information from the reader apparatus. The A-IoT devices may obtain the essential instructions for responding, e.g., the T/F resources or the ID of the UE reader, from the command. In addition, the reader apparatus may append CRC for error checking and the A-IoT devices may use the CRC for the error detection and the error correction.

The communication format 2 may not comprise the carrier component. The communication format 2 may only comprise a preamble, a command, and a CRC. The communication format 2 may be used when the A-IoT devices do not require an RF charging signal, or when the A-IoT devices have access to another energy sources.

FIG. 28 may illustrate two communication strategies between the reader apparatus and the A-IoT devices. The first strategy may involve the communication format 1. In the first strategy, the reader apparatus may directly provide the energy and messages to the A-IoT device. The second strategy may involve the communication format 2. In the second strategy, the reader apparatus may only transmit the message to the A-IoT device, and a separate carrier source may provide the carrier waveform for charging the A-IoT device. In order to avoid the interference, the reader apparatus and the carrier source may be coordinated by the network node. For instance, the carrier source may use the UL frequency (or UL spectrum) to broadcast the carrier waveform within the T/F resources allocated by the network node. The coordination may ensure that the A-IoT devices can receive energy and information without the signal conflict.

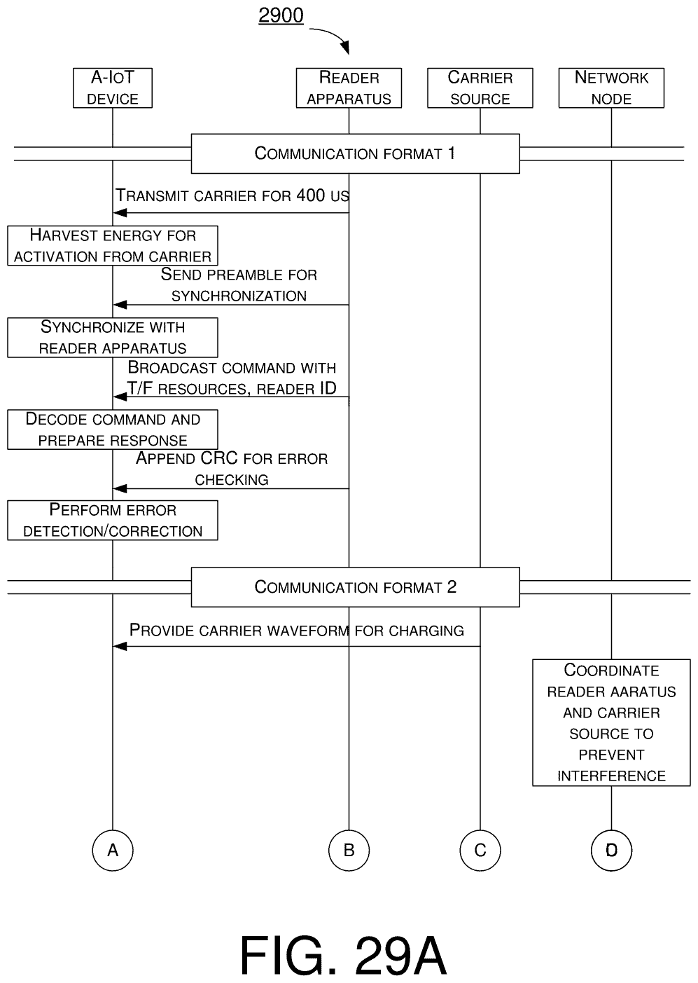

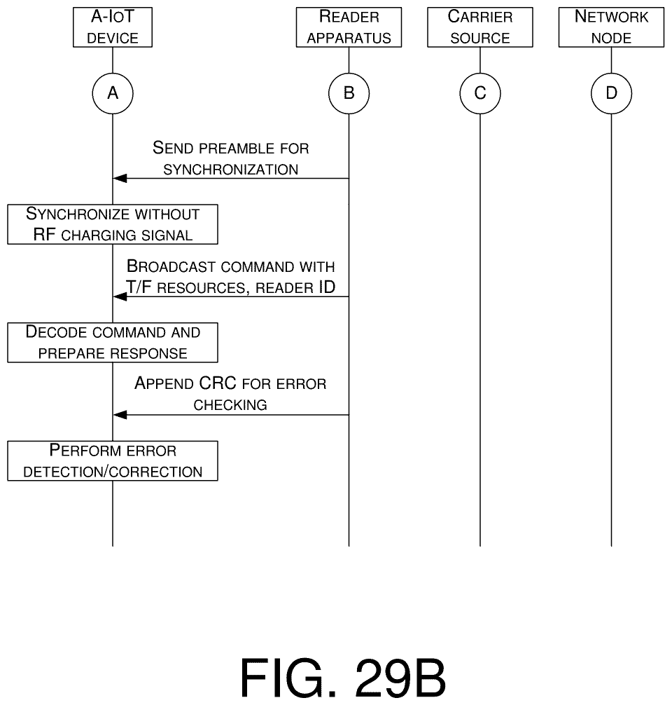

FIGS. 29A-29B illustrates an example scenario 2900 for a communication process for different communication formats in accordance with implementations of the present disclosure. Scenario 2900 involves a reader apparatus (e.g., a UE, a UE reader, or a network node), an A-IoT device, a carrier source, and a network node (e.g., a (macro/micro) base station) which may be a part of a wireless network (e.g., an LTE network, a 5G/NR network, an IoT network or a 6G network). Referring to FIGS. 29A-29B, two communication formats of DL communication may be used between the reader apparatus and A-IoT devices. For the communication format 1, the reader apparatus may directly provide the energy to the A-IoT device through a carrier signal. The IoT device harvest energy for activation from carrier. The reader apparatus may also transmit a preamble for synchronization to the A-IoT device. Then, the IoT device may synchronize with reader apparatus according to the preamble. The reader apparatus may also transmit (or broadcast) a command comprising the essential information (T/F resources, reader ID) for the response of the A-IoT device. The IoT device may decode the command and prepare the response based on the essential information. The reader apparatus may further transmit (or append) the CRC for the error checking.

For the communication format 2, a separate carrier source may provide the carrier waveform for A-IoT device charging, and the reader apparatus may only transmit the preamble, the command, and the CRC to the A-IoT device. The network node may coordinate the reader apparatus and the carrier source to avoid the interference to ensure that the A-IoT device can receive the necessary information and energy without conflict. The reader apparatus may send the preamble for synchronization and the A-IoT devices may use the preamble for synchronization without RF charging signal. The reader apparatus may also broadcast a command comprising T/F resources, reader ID and so on. The A-IoT devices may decode the command to obtain the essential instructions for responding. In addition, the reader apparatus may append CRC for error checking and the A-IoT devices may use the CRC for the error detection and the error correction.

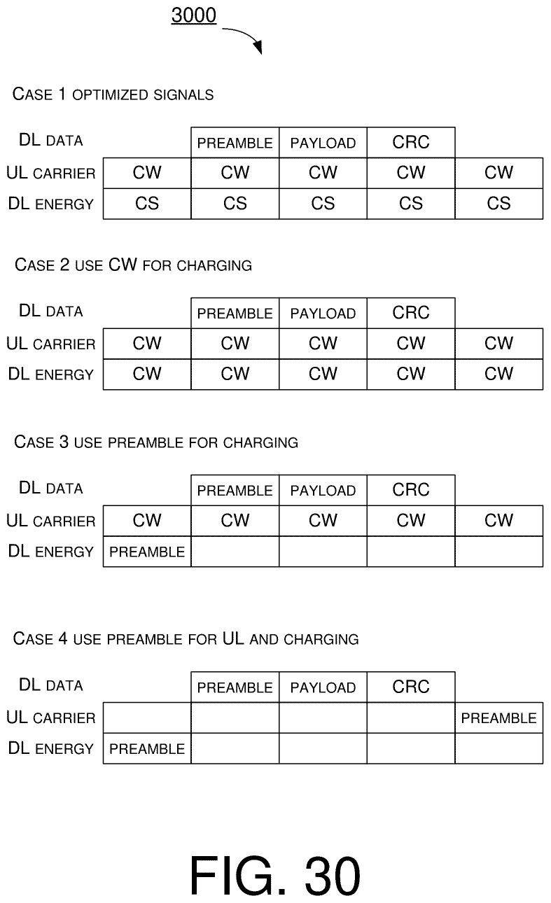

FIG. 30 illustrates an example scenario 3000 for frame structures in accordance with implementations of the present disclosure. Scenario 3000 involves an A-IoT device (e.g., an A-IoT tag), a DL data source, a DL energy source, and an UL carrier source, where the DL data source and the DL energy source may be a reader apparatus (e.g., a UE reader or a network node). As shown in FIG. 30, the frame structures may comprise four cases for performing the battery charging through a charging signal (CS). The CS may vary in complexity from a single-tone signal to a multi-tone signal. For the DL data transmission, the frame structure may be an RFID-like signal format which may comprise a preamble for synchronization, a data payload, and a CRC for error checking. The UL data transmission may be performed through a carrier waveform (CW) which is suitable for backscattering. The CW may also comprise single-tone and multi-tone.

The frame structure may provide specific waveforms for each function to increase the performance. However, for the requirement of system simplicity, a shared waveform and frame structure may be used to perform multiple functions. In the frame structure, individual signals may be optimized for respective tasks, or a common signal (e.g., the carrier wave or preamble) may be used to handle both energy delivery and data synchronization.

The designed cases shown in FIG. 30 may consider the dual use of signals. In an example, as shown in case 1, the CS may be used for the DL energy charging. In addition, the CW may be taken as the UL carrier. In an example, as shown in case 2, the CW may be used for the DL energy transfer and taken as the UL carrier. In another example, as shown in case 3, the preamble may be used for charging and for synchronizing the DL data. In addition, the CW may be taken as the UL carrier. In addition, as shown in case 4, the preamble may also be used for DL data, UL carrier, and DL charging to simplify the frame structure.

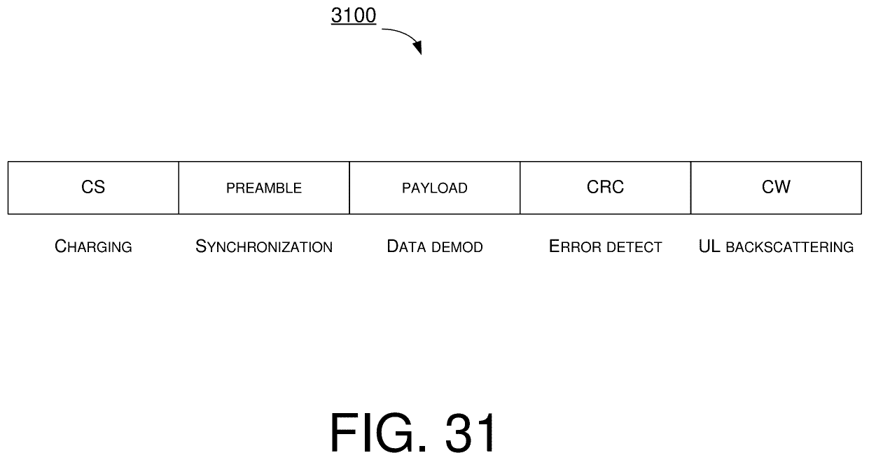

FIG. 31 illustrates an example scenario 3100 for a sequence of operations associated with the A-IoT device in accordance with implementations of the present disclosure. Scenario 3100 involves an A-IoT device (e.g., an A-IoT tag), a DL data source, a DL energy source, and a UL carrier source. As shown in FIG. 3100, in the sequence of operations (or operational timeline), the A-IoT device may receive a charging signal (CS) to obtain the energy which is required for its functions. When the A-IoT device has charged sufficiently, the A-IoT device may start to monitor a preamble signal to perform time and frequency synchronization to ensure that the A-IoT device can accurately interpret the incoming data.

After the synchronization, the A-IoT device may demodulate the data payload which may comprise the main content of the communication allocated for the A-IoT device. After the demodulation, the A-IoT device may check the CRC to ensure the data integrity and to detect any transmission errors.

If the received payload indicates that a UL transmission is required, the A-IoT device may perform the UL backscattering. In an implementation, the A-IoT device may use the CW to modulate and reflect its own data back to the reader apparatus (e.g., UE reader or network node) to complete the communication cycle. The sequence of operations from the energy charging to the UL communication (i.e., the UL backscattering) may comprise all activities of the A-IoT device within a communication session.

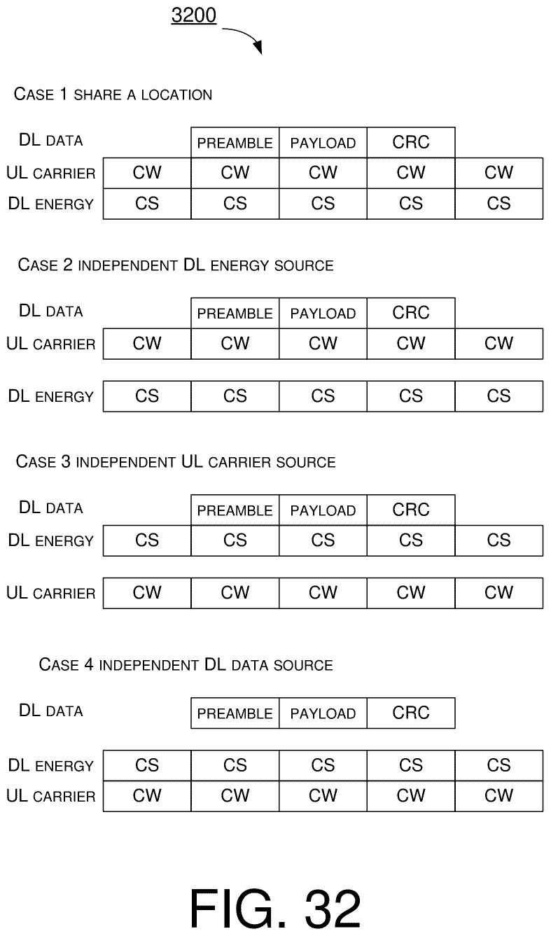

FIG. 32 illustrates an example scenario 3200 for different configuration strategies in accordance with implementations of the present disclosure. Scenario 3200 involves an A-IoT device (e.g., an A-IoT tag), a DL data source, a DL energy source, and a UL carrier source. As shown in FIG. 32, different strategies for configuring (or deploying) the sources for the DL data, UL carrier, and DL energy within an A-IoT network are illustrated. FIG. 32 may provide different configurations (placements) for the above sources to optimize the interface efficiency and the spectrum resource utilization.

In an ideal configuration (deployment) scenario, the sources for the DL data, the UL carrier, and the DL energy may be allocated in separate locations to reduce the interference between the different types of signals and achieve better use for the available spectrum.

In an example, as shown in case 1, a simpler configuration method may involve co-locating all sources, all sources may share a location. The configuration may have a straightforward setup, but the higher signal interference and less efficient use of the spectrum may occur.

In another example, as shown in cases 2-4, one of the sources (e.g., the DL energy source, UL carrier source, or DL data source) may be positioned independently. Each configuration may have its own advantages and challenges based on the network performance.

The analysis of the configuration strategies may focus on the practical implications, such as the design of communication frames allocated to the A-IoT devices, the allocation and management of radio resources, and the methods for managing potential interference. The most effective and practical configuration strategy may be determined for applying the A-IoT devices into the communication network to ensure the reliable communication and maintain a manageable level of the network complexity.

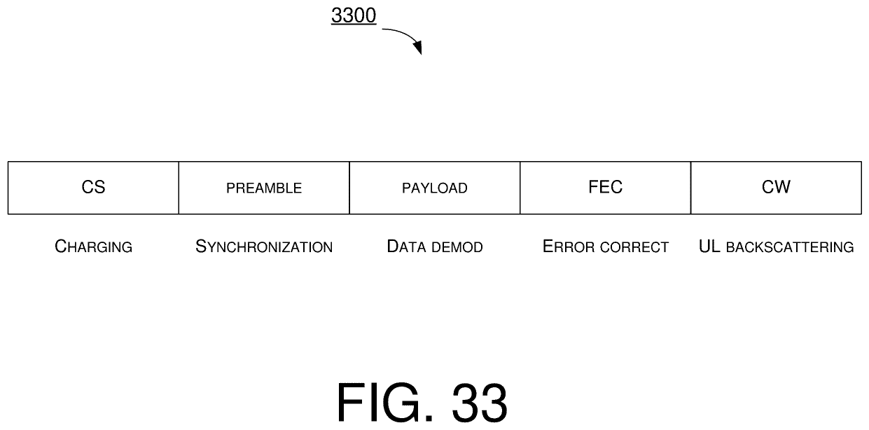

FIG. 33 illustrates another example scenario 3300 for a sequence of operations associated with the A-IoT device in accordance with implementations of the present disclosure. Scenario 3300 involves an A-IoT device (e.g., an A-IoT tag), a DL data source, a DL energy source, and a UL carrier source. As shown in FIG. 33, the forward error correction (FEC) methods may be used in the RFID systems (e.g., the A-IoT systems). Comparing to the CRC, although the FEC may increase the complexity and data overhead, the FEC may reduce the unnecessary retransmissions by correcting certain errors directly.

The CRC method may be straightforward. In the CRC method, a checksum may be generated from the data using a polynomial formula. If the checksum does not match at the receiver end, it means that an error occurs. However, the CRC method may be stopped at the error detection. That is, the CRC method may not provide a solution for error correction. As a result, the data may need to be retransmitted to overcome the detected errors.

The FEC method (e.g., the Hamming Code) may provide a more proactive approach. In the FEC method, additional redundancy bits may be incorporated into the data to allow the detection of errors and enable the correction of errors. The immediate correction capability of FEC may reduce the latency and overhead caused by the retransmissions.

Comparing to the CRC method, the FEC method may have higher complexity, but it can reduce the latency based on its error-correcting abilities. Therefore, even if the data overhead may be increased in the FEC method, the reduction for retransmissions may achieve a more efficient communication system overall.

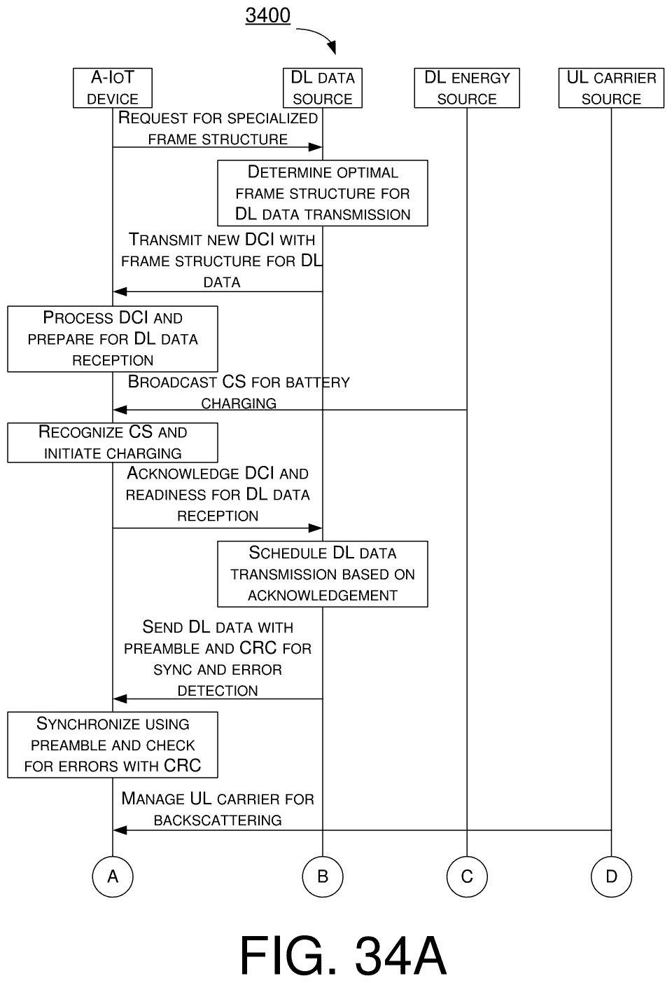

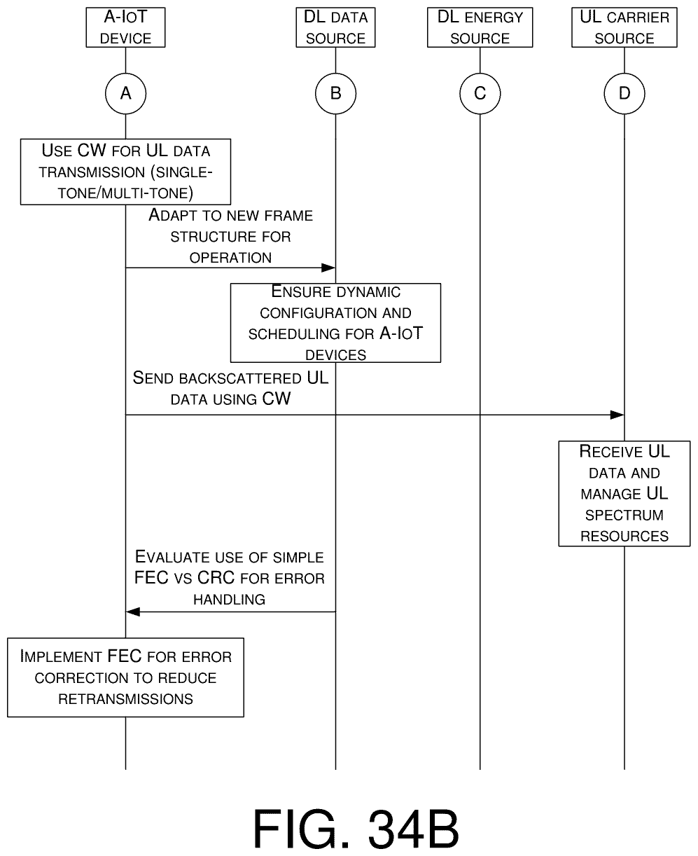

FIGS. 34A-34B illustrate an example scenario 3400 for a communication process for the A-IoT device in accordance with implementations of the present disclosure. Scenario 3400 involves an A-IoT device (e.g., an A-IoT tag), a DL data source, a DL energy source, and a UL carrier source. As shown in FIGS. 34A-34B, the communication process may comprise the operation of transmitting a request for a specialized frame structure from the A-IoT device to the DL data source. Then, the DL data source may determine the optimal frame structure for the DL data transmission. The communication process may also comprise the operation of transmitting a new DCI with the frame structure for DL data from the DL data source to the A-IoT device. Then, the A-IoT device may process the DCI and prepare for the DL data reception. The communication process may also comprise the operation of broadcasting a CS for battery charging from the DL energy source. Then, the A-IoT device may recognize the CS and initiate the battery charging. The communication process may also comprise the operation of transmitting an acknowledgement for the DCI and the readiness DL data reception from the A-IoT device to the DL data source. Then, the DL data source may schedule the DL data transmission based on the acknowledgement. The communication process may also comprise the operations of transmitting the DL data with a preamble for synchronization from the DL data source, and transmitting the CRC for the error detection from the DL data source. Then, the A-IoT device may synchronize according to the preamble and check for error according to the CRC. The communication process may also comprise the operation of managing the UL carrier for the backscattering from the UL carrier source. Then, the A-IoT device may use the CW for UL data transmission (single-tone/multi-tone). The communication process may also comprise the operation of adapting to the new frame structure for operation. Then, the DL data source may ensure the dynamic configuration and scheduling for the A-IoT devices. The communication process may also comprise the operation of sending the backscattered UL data to the UL carrier source through the CW. Then, the UL carrier source may receive the UL data and manage the UL spectrum resources. The communication process may also comprise the operation of evaluating the error detection and correction strategies (e.g., simple FEC or CRC). Then, the A-IoT device may implement the FEC for error correction to reduce retransmissions. The correction strategies may comprise that the simple FEC methods may be used to minimize the retransmissions and optimize the system efficiency. The communication process of FIGS. 34A-34B may focus on the battery charging, the DL data transmission, and the UL data transmission within the A-IoT frame structure.

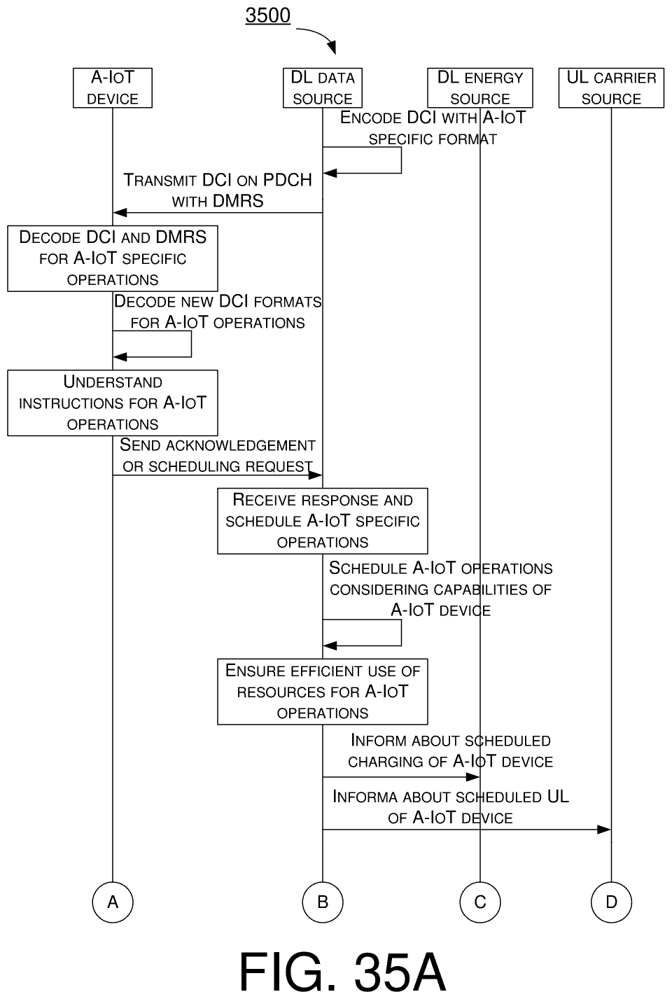

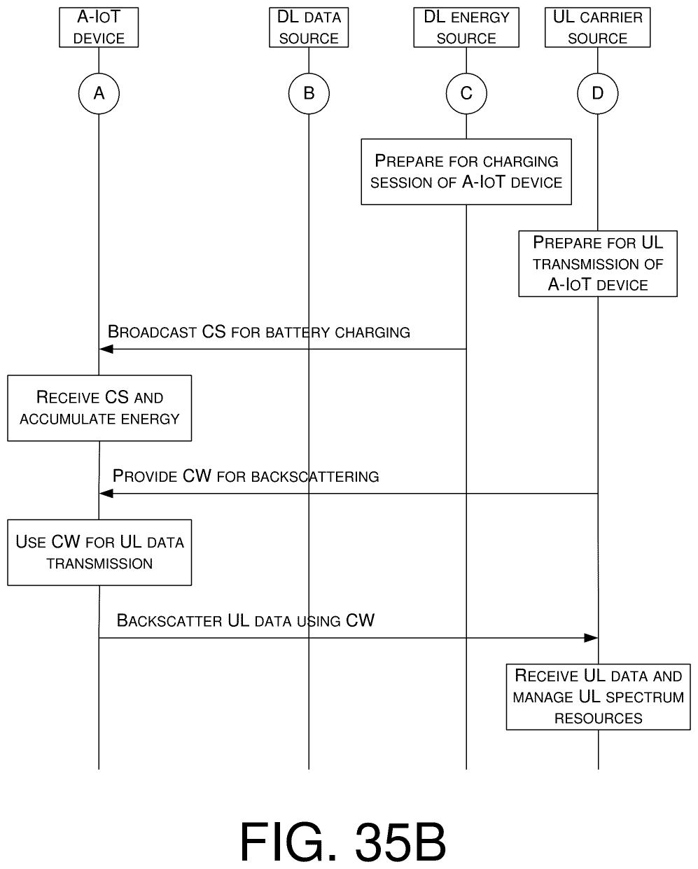

FIGS. 35A-35B illustrate another example scenario 3500 for a communication process for the A-IoT device in accordance with implementations of the present disclosure. Scenario 3500 involves an A-IoT device (e.g., an A-IoT tag), a DL data source, a DL energy source, and a UL carrier source. As shown in FIGS. 35A-35B, the communication process may comprise the operation of encoding the downlink control information (DCI) messages with A-IoT formats through the DL data source and transmitting the DCI messages with the A-IoT formats on the PDCCH which may comprise the DeModulation Reference Signal (DMRS). The A-IoT device may decode the information (e.g., DMRS, DCI formats and instructions in the DCI messages) for the A-IoT specific operations or A-IoT operations and transmit an acknowledgment or a scheduling request to the DL data source. The DL data source may schedule the A-IoT-specific operations according to the capabilities of the A-IoT device to ensure efficient use of resources for the A-IoT operations, and respectively inform the DL energy source and UL carrier source about the scheduled operations for the charging and the UL transmission of the A-IoT device. Then, the DL energy source may prepare for charging session of the A-IoT device, and the UL carrier source may prepare for the UL transmission of the A-IoT device. The DL energy source may broadcast a CS for battery charging to the A-IoT device. The A-IoT device may receive the CS and accumulate the energy. The UL carrier source may provide a CW for the backscattering of the A-IoT device. The A-IoT device may use the CW for UL data transmission to complete the communication cycle. The A-IoT device may use the CW for backscattering the UL data to the UL carrier source. The UL carrier source may receive the UL data and manage the UL spectrum resources. The communication process of FIGS. 35A-35B may focus on the A-IoT-specific operations and the coordination between the different sources to ensure efficient resource use and communication.

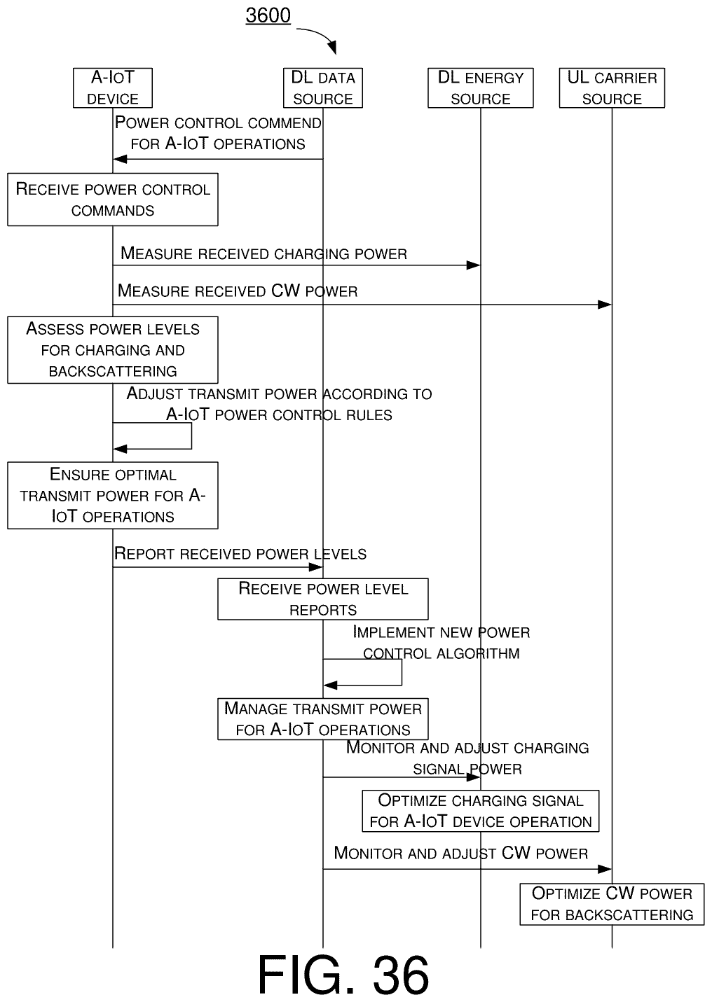

FIG. 36 illustrates another example scenario 3600 for a communication process for the A-IoT device in accordance with implementations of the present disclosure. Scenario 3600 involves an A-IoT device (e.g., an A-IoT tag), a DL data source, a DL energy source, and a UL carrier source. As shown in FIG. 36, the UL power control process may be applied for the A-IoT systems. In the communication process, the DL data source may transmit (or send) the power control commands to the A-IoT device. Then, the A-IoT device may measure the received charging power from the DL energy source and the received CW power from the UL carrier source for the charging and the backscattering. The A-IoT device may assess the power levels for charging and backscattering. The A-IoT device may adjust its transmit power according to the new A-IoT power control rules to ensure the optimal transmit power for the A-IoT operations and reports the received power levels to the DL data source. The DL data source may receive the power level reports and use (or implement) the new power control algorithms to manage the transmit power for the A-IoT devices. The DL data source may also monitor and adjust the power of the charging signal for the optimizing operations of the DL energy source (i.e., optimize the charging for the A-IoT device operation). The DL data source may also monitor and adjust the CW for the optimizing operations the UL carrier source (i.e., optimize the CW power for the backscattering). The communication process of FIG. 36 may focus on the A-IoT-specific power control and the coordination between the different sources to ensure efficient power management and device operation.

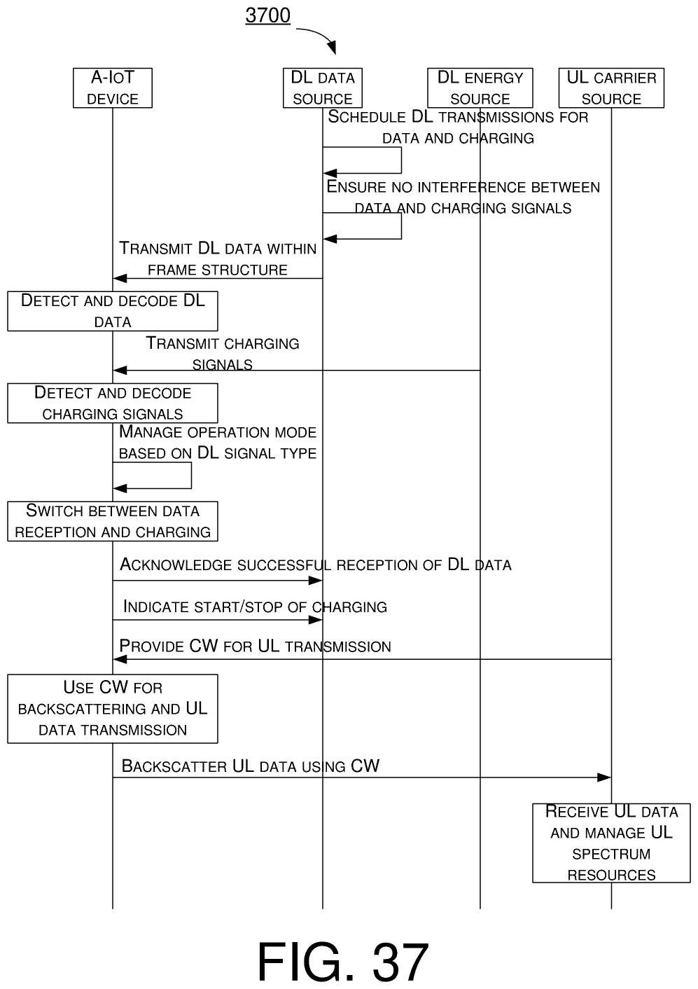

FIG. 37 illustrates another example scenario 3700 for a communication process for the A-IoT device in accordance with implementations of the present disclosure. Scenario 3700 involves an A-IoT device (e.g., an A-IoT tag), a DL data source, a DL energy source, and a UL carrier source. As shown in FIG. 37, the UL carrier source may provide a CW for the UL transmission of the A-IoT device. In the communication process, the CW may be required for the backscattering. The communication process may begin with the DL data source scheduling DL transmissions for data and charging and ensuring no interference between the two types of signals (i.e., the data and the charging signals). The DL data source may transmit the DL data within a unified or specialized frame structure to the A-IoT device. Then, the A-IoT device may detect and decode the DL data. The DL energy source may transmit the charging signals to the A-IoT device. Then, the A-IoT device may detect and decode the charging signals. The A-IoT device may manage its operation mode based on the type of the received DL signal (or DL data), and switch between the data reception and the charging. The A-IoT device may also acknowledge the successful reception of DL data. The A-IoT device may also indicate the start or stop of charging to the DL data source. The UL carrier source may provide the CW for the UL transmission of the A-IoT device. The A-IoT device may perform the UL backscattering using the CW. The A-IoT device may use the CW for backscattering the UL data to the UL carrier source. The UL carrier source may receive the UL data and manage the UL spectrum resources. The communication process of FIG. 37 may focus on the A-IoT-specific channel access and the coordination between the different sources to ensure the efficient data transmission, energy management, and UL communication.

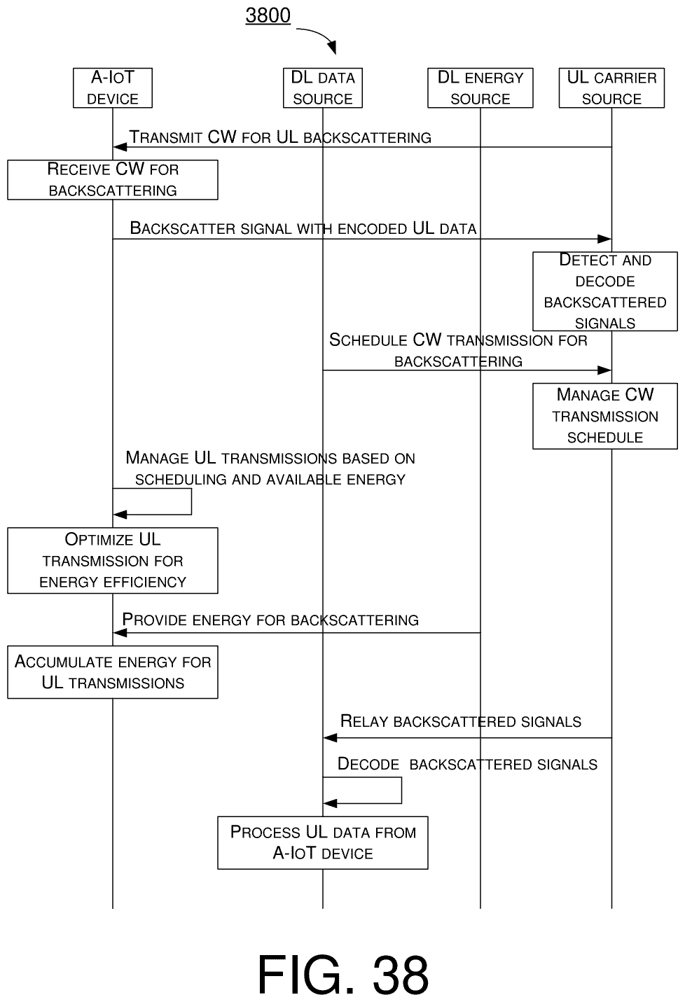

FIG. 38 illustrates another example scenario 3800 for a communication process for the A-IoT device in accordance with implementations of the present disclosure. Scenario 3800 involves an A-IoT device (e.g., an A-IoT tag), a DL data source, a DL energy source, and a UL carrier source. As shown in FIG. 38, the UL carrier source may transmit a CW for the UL backscattering to the A-IoT device. The A-IoT device may receive the CW and use the CW to backscatter the signal with encoded UL data to the UL carrier resource. The UL carrier source may detect and decode the backscattered signals. The DL data source may schedule the CW transmission for the UL backscattering according to the energy status of the A-IoT device. The UL carrier source may manage the CW transmission schedule. The A-IoT device may manage its UL transmissions according to the scheduling of the DL data source and the available energy provided by the DL energy source for backscattering to optimize the UL transmission for the energy efficiency. The DL energy source may provide energy for the backscattering to the A-IoT device. Then, the A-IoT device may accumulate the energy for the UL transmission. The DL data source may receive the relay backscattered signals from the UL carrier source and detect and decode the backscattered signals from the A-IoT device. Then, the DL data source may process the UL data from the A-IoT device. The communication process of FIG. 38 may focus on the A-IoT-specific channel access and the coordination between the different sources to ensure the efficient UL communication and energy management.

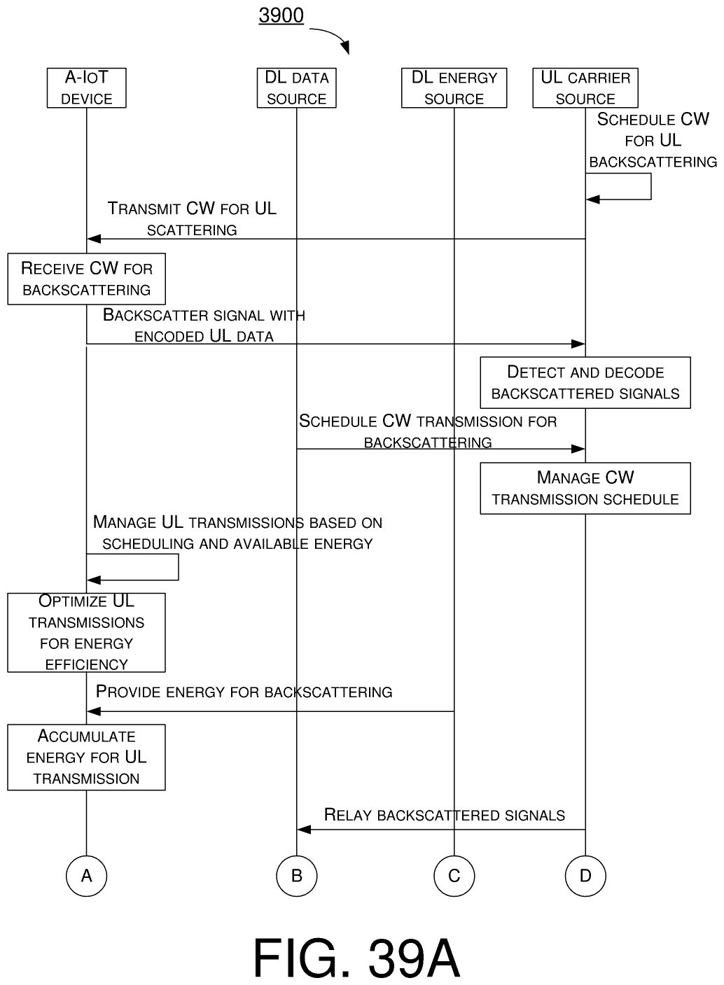

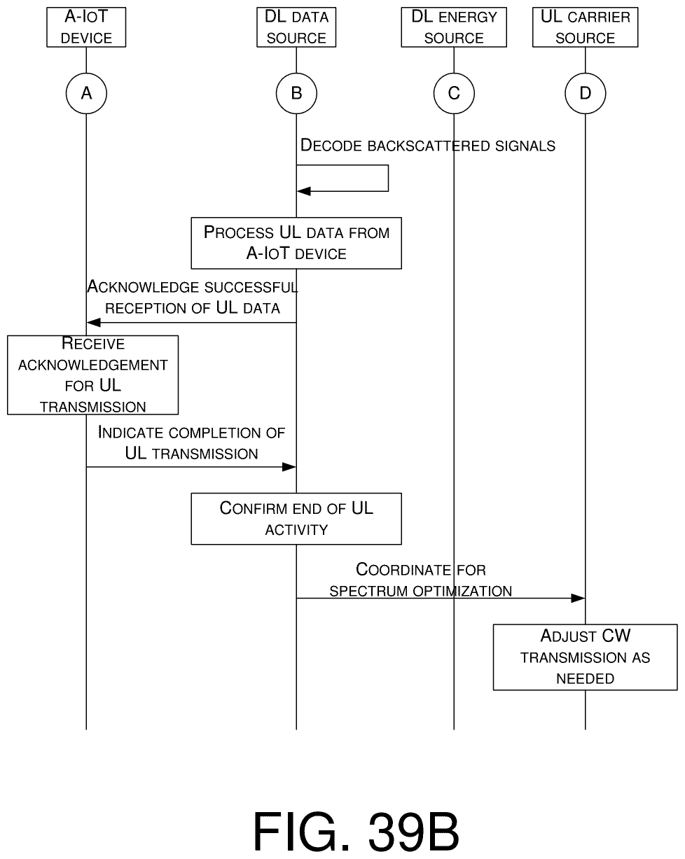

FIGS. 39A-39B illustrate another example scenario 3900 for a communication process for the A-IoT device in accordance with implementations of the present disclosure. Scenario 3900 involves an A-IoT device (e.g., an A-IoT tag), a DL data source, a DL energy source, and a UL carrier source. As shown in FIGS. 39A-39B, the UL carrier source may schedule a CW for the UL backscattering and transmit the CW to the A-IoT device. The A-IoT device may receive the CW and use the CW to backscatter the signal with encoded UL data to the UL carrier source. Then, the UL carrier source may detect and decode the backscattered signals. The DL data source may schedule the CW transmission for the UL backscattering according to the energy status of the A-IoT device. The UL carrier source manage the CW transmission schedule. The A-IoT device may manage its UL transmissions according to the scheduling of the DL data source and the available energy provided by the DL energy source for backscattering to optimize the UL transmission for the energy efficiency. The DL energy source may provide energy for the backscattering to the A-IoT device. Then, the A-IoT device may accumulate the energy for the UL transmission. The DL data source may receive the relay backscattered signals from the UL carrier source and detect and decode the backscattered signals from the A-IoT device. Then, the DL data source may process the UL data from the A-IoT device. The DL data source may also acknowledge the successful reception of the UL data. The A-IoT device may receive the acknowledgement for the UL transmission and indicate the completion of the UL transmission. The DL data source may confirm the end of UL activity. The DL data source and UL carrier source may coordinate to optimize the spectrum resources. The UL carrier source may adjust the CW transmission. The communication process of FIGS. 39A-39B may focus on the A-IoT-specific channel access and the coordination between the different sources to ensure the efficient UL communication and energy management.

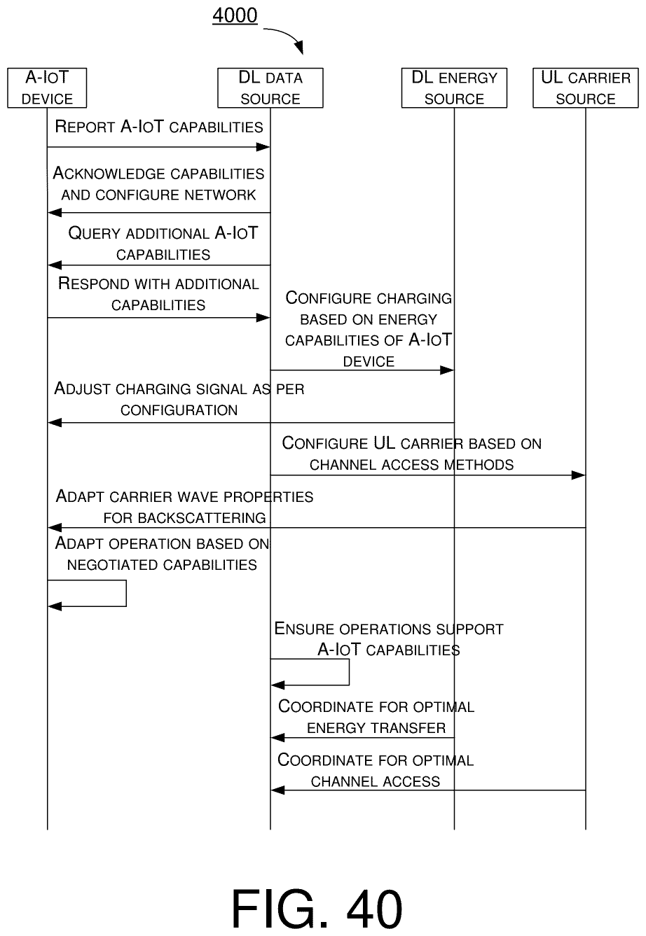

FIG. 40 illustrates another example scenario 4000 for a communication process for the A-IoT device in accordance with implementations of the present disclosure. Scenario 4000 involves an A-IoT device (e.g., an A-IoT tag), a DL data source, a DL energy source, and a UL carrier source. As shown in FIG. 40, the A-IoT device may report its capabilities to the DL data source. The DL data source may acknowledge the capabilities and configure the network to support the capabilities. The DL data source may query additional capabilities from the A-IoT device. The A-IoT device may respond with the additional capabilities. Based on the energy reception capabilities of the A-IoT device, the DL data source may configure the DL energy source to adjust the charging signal. The DL energy source may adjust the charging signal according the configuration. The DL data source may also configure the UL carrier to the UL carrier source based on the channel access methods of the A-IoT device to provide a CW which aligns with the backscattering capabilities of the A-IoT device. The UL carrier source may adapt the carrier wave properties for the backscattering of the A-IoT device. The A-IoT device may adapt its operation according to the negotiated capabilities. The DL data source may ensure that the network operations support the capabilities of the A-IoT device. The DL energy source and UL carrier source may coordinate with the DL data source to optimize the energy transfer and the channel access to ensure the efficient operation of the A-IoT system.

### Illustrative Implementations

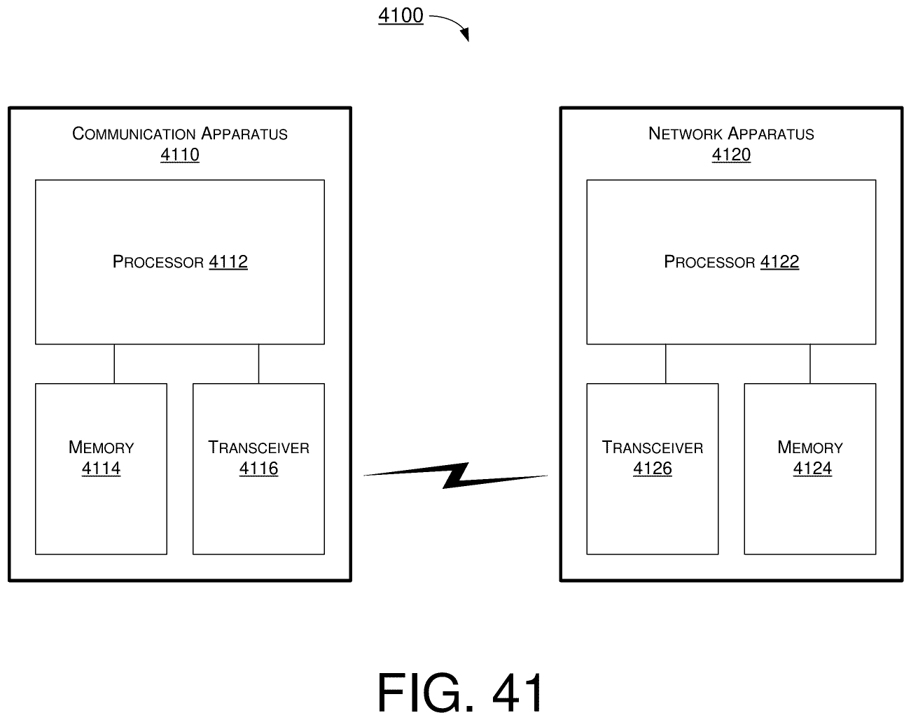

FIG. 41 illustrates an example communication system 4100 having at least an example communication apparatus 4110 and an example network apparatus 4120 in accordance with an implementation of the present disclosure. Each of communication apparatus 4110 and network apparatus 4120 may perform various functions to implement schemes, techniques, processes and methods described herein pertaining to IoT signal transmission, including the various schemes described above with respect to various proposed designs, concepts, schemes and methods described above and with respect to user equipment and network apparatus in mobile communications, including scenarios/schemes described above as well as process 4200 and process 4300 described below.

Communication apparatus 4110 may be a part of an electronic apparatus, which may be a UE such as a portable or mobile apparatus, a wearable apparatus, a wireless communication apparatus or a computing apparatus. For instance, communication apparatus 4110 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 4110 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 4110 may be implemented in a smart thermostat, a smart fridge, a smart door lock, a wireless speaker or a home control center. Alternatively, communication apparatus 4110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 4110 may include at least some of those components shown in FIG. 41 such as a processor 4112, for example. Communication apparatus 4110 may further include one or more other components not pertinent to the proposed schemes of the present disclosure (e.g., internal power supply, display device and/or user interface device), and, thus, such component(s) of communication apparatus 4110 are neither shown in FIG. 41 nor described below in the interest of simplicity and brevity.

Network apparatus 4120 may be a part of an electronic apparatus, which may be a network node such as a satellite, a BS, a small cell, a router or a gateway of an IoT network. For instance, network apparatus 4120 may be implemented in a satellite or an eNB/gNB/TRP in a 4G/5G/B5G/6G, NR, IoT, NB-IoT or IIoT network. Alternatively, network apparatus 4120 may be implemented in the form of one or more IC chips such as, for example and without limitation, one or more single-core processors, one or more multi-core processors, or one or more RISC or CISC processors. Network apparatus 4120 may include at least some of those components shown in FIG. 41 such as a processor 4122, for example. Network apparatus 4120 may further include one or more other components not pertinent to the proposed scheme of the present disclosure (e.g., internal power supply, display device and/or user interface device), and, thus, such component(s) of network apparatus 4120 are neither shown in FIG. 41 nor described below in the interest of simplicity and brevity.

In one aspect, each of processor 4112 and processor 4122 may be implemented in the form of one or more single-core processors, one or more multi-core processors, or one or more CISC processors. That is, even though a singular term “a processor” is used herein to refer to processor 4112 and processor 4122, each of processor 4112 and processor 4122 may include multiple processors in some implementations and a single processor in other implementations in accordance with the present disclosure. In another aspect, each of processor 4112 and processor 4122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 4112 and processor 4122 is a special-purpose machine specifically designed, arranged and configured to perform specific tasks, including IoT signal transmission, in a device (e.g., as represented by communication apparatus 4110) and a network node (e.g., as represented by network apparatus 4120) in accordance with various implementations of the present disclosure.

In some implementations, communication apparatus 4110 may also include a transceiver 4116 coupled to processor 4112 and capable of wirelessly transmitting and receiving data. In some implementations, transceiver 4116 may be capable of wirelessly communicating with different types of UEs and/or wireless networks of different radio access technologies (RATs). In some implementations, transceiver 4116 may be equipped with a plurality of antenna ports (not shown) such as, for example, four antenna ports. That is, transceiver 4116 may be equipped with multiple transmit antennas and multiple receive antennas for multiple-input multiple-output (MIMO) wireless communications. In some implementations, network apparatus 4120 may also include a transceiver 4126 coupled to processor 4122. Transceiver 4126 may include a transceiver capable of wirelessly transmitting and receiving data. In some implementations, transceiver 4126 may be capable of wirelessly communicating with different types of UEs of different RATs. In some implementations, transceiver 4126 may be equipped with a plurality of antenna ports (not shown) such as, for example, four antenna ports. That is, transceiver 4126 may be equipped with multiple transmit antennas and multiple receive antennas for MIMO wireless communications.

In some implementations, communication apparatus 4110 may further include a memory 4114 coupled to processor 4112 and capable of being accessed by processor 4112 and storing data therein. In some implementations, network apparatus 4120 may further include a memory 4124 coupled to processor 4122 and capable of being accessed by processor 4122 and storing data therein. Each of memory 4114 and memory 4124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 4114 and memory 4124 may include a type of read-only memory (ROM) such as mask ROM, programmable ROM (PROM), erasable programmable ROM (EPROM) and/or electrically erasable programmable ROM (EEPROM). Alternatively, or additionally, each of memory 4114 and memory 4124 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 4110 and network apparatus 4120 may be a communication entity capable of communicating with each other using various proposed schemes in accordance with the present disclosure. For illustrative purposes and without limitation, descriptions of capabilities of communication apparatus 4110, as a UE, and network apparatus 4120, as a network node (e.g., TRP), are provided below with process 4200 and process 4300.

### Illustrative Processes

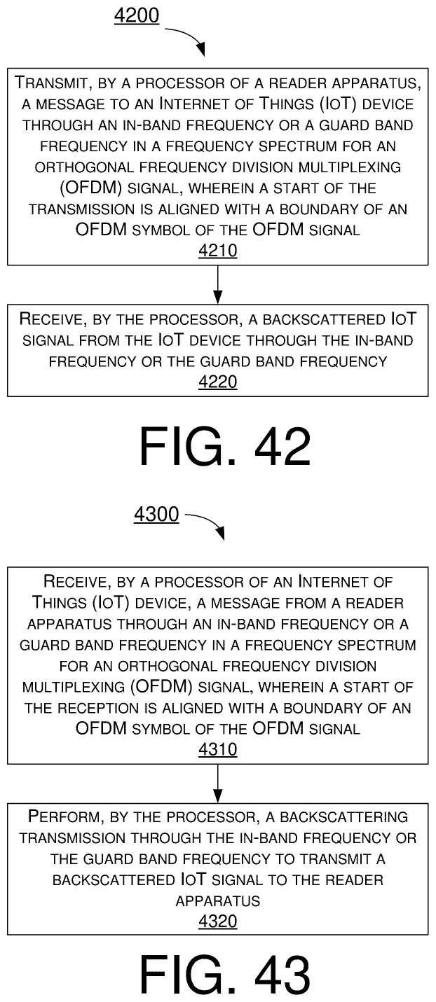

FIG. 42 illustrates an example process 4200 in accordance with an implementation of the present disclosure. Process 4200 may be an example implementation of above scenarios/schemes, whether partially or completely, with respect to IoT signal transmission with the present disclosure. Process 4200 may represent an aspect of implementation of features of communication apparatus 4110. Process 4200 may include one or more operations, actions, or functions as illustrated by one or more of blocks 4210 and 4220. Although illustrated as discrete blocks, various blocks of process 4200 may be divided into additional blocks, combined into fewer blocks, or eliminated, depending on the desired implementation. Moreover, the blocks of process 4200 may be executed in the order shown in FIG. 42 or, alternatively, in a different order. Process 4200 may be implemented by communication apparatus 4110 or any suitable reader apparatus. Solely for illustrative purposes and without limitation, process 4200 is described below in the context of communication apparatus 4110. Process 4200 may begin at block 4210.

At block 4210, process 4200 may involve processor 4112 of communication apparatus 4110 transmitting, via transceiver 4116, a message to an IoT device through an in-band frequency or a guard band frequency in a frequency spectrum for an OFDM signal, wherein a start of the transmission is aligned with a boundary of an OFDM symbol of the OFDM signal. Process 4200 may proceed from block 4210 to block 4220.

At block 4220, process 4200 may involve processor 4112 receiving, via transceiver 4116, a backscattered IoT signal from the IoT device through the in-band frequency or the guard band frequency.

In some implementations, the in-band frequency is configured for a UL transmission or a DL transmission of the OFDM signal.

In some implementations, the guard band frequency is configured between two OFDM signals.

In some implementations, an IoT guard band is configured between the OFDM signal and an IoT signal.

In some implementations, process 4200 may involve processor 4112 transmitting, via transceiver 4116, a CW to the IoT device, wherein the CW is configured to provide energy to the IoT device.

In some implementations, the CW is transmitted in at least one of an UL spectrum and a DL spectrum for the OFDM signal, and wherein the CW is transmitted from inside a system for the OFDM signal in the DL spectrum, or the CW is transmitted from inside the system for the OFDM signal in the UL spectrum, or the CW is transmitted from outside the system for the OFDM signal in the UL spectrum.

In some implementations, the CW may be transmitted through a carrier resource of the message or through another carrier resource.

FIG. 43 illustrates an example process 4300 in accordance with another implementation of the present disclosure. Process 4300 may be an example implementation of above scenarios/schemes, whether partially or completely, with respect to IoT signal transmission with the present disclosure. Process 4300 may represent an aspect of implementation of features of communication apparatus 4110. Process 4300 may include one or more operations, actions, or functions as illustrated by one or more of blocks 4310 and 4320. Although illustrated as discrete blocks, various blocks of process 4300 may be divided into additional blocks, combined into fewer blocks, or eliminated, depending on the desired implementation. Moreover, the blocks of process 4300 may be executed in the order shown in FIG. 43 or, alternatively, in a different order. Process 4300 may be implemented by communication apparatus 4110 or any suitable IoT device. Solely for illustrative purposes and without limitation, process 4300 is described below in the context of communication apparatus 4110. Process 4300 may begin at block 4310.

At block 4310, process 4300 may involve processor 4112 of communication apparatus 4110 receiving, via transceiver 4116, a message from a reader apparatus through an in-band frequency or a guard band frequency in a frequency spectrum for an OFDM signal, wherein a start of the reception is aligned with a boundary of an OFDM symbol of the OFDM signal. Process 4300 may proceed from block 4310 to block 4320.

At block 4320, process 4300 may involve processor 4112 performing a backscattering transmission through the in-band frequency or the guard band frequency to transmit a backscattered IoT signal to the reader apparatus.

In some implementations, process 4300 may involve processor 4112 receiving, via transceiver 4116, a CW from the reader apparatus, wherein the CW is used to provide energy to the IoT device.

In some implementations, the CW is transmitted in at least one of an UL spectrum and a DL spectrum for the OFDM signal, and wherein the CW is received from inside a system for the OFDM signal in the DL spectrum, or the CW is received from inside the system for the OFDM signal in the UL spectrum, or the CW is received from outside the system for the OFDM signal in the UL spectrum.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a reader apparatus, a message to an Internet of Things (IoT) device through an in-band frequency or a guard band frequency in a frequency spectrum for an orthogonal frequency division multiplexing (OFDM) signal, wherein a start of the transmission is aligned with a boundary of an OFDM symbol of the OFDM signal; and
receiving, by the processor, a backscattered IoT signal from the IoT device through the in-band frequency or the guard band frequency.

2. The method of claim 1, wherein the in-band frequency is configured for an uplink (UL) transmission or a downlink (DL) transmission of the OFDM signal.

3. The method of claim 1, wherein the guard band frequency is configured between two OFDM signals.

4. The method of claim 1, wherein an IoT guard band is configured between the OFDM signal and an IoT signal.

5. The method of claim 1, further comprising:
transmitting, by the processor, a carrier waveform (CW) to the IoT device, wherein the CW is configured to provide energy to the IoT device.

6. The method of claim 5, wherein the CW is transmitted in at least one of an uplink (UL) spectrum and a downlink (DL) spectrum for the OFDM signal, and wherein the CW is transmitted from inside a system for the OFDM signal in the DL spectrum, or the CW is transmitted from inside the system for the OFDM signal in the UL spectrum, or the CW is transmitted from outside the system for the OFDM signal in the UL spectrum.

7. The method of claim 5, wherein the CW is transmitted through a carrier resource of the message or through another carrier resource.

8. A method, comprising:
receiving, by a processor of an Internet of Things (IoT) device, a message from a reader apparatus through an in-band frequency or a guard band frequency in a frequency spectrum for an orthogonal frequency division multiplexing (OFDM) signal, wherein a start of the reception is aligned with a boundary of an OFDM symbol of the OFDM signal; and
performing, by the processor, a backscattering transmission through the in-band frequency or the guard band frequency to transmit a backscattered IoT signal to the reader apparatus.

9. The method of claim 8, wherein the in-band frequency is configured for an uplink (UL) transmission or a downlink (DL) transmission of the OFDM signal.

10. The method of claim 8, wherein the guard band frequency is configured between two OFDM signals.

11. The method of claim 8, wherein an IoT guard band frequency is configured between the OFDM signal and an IoT signal.

12. The method of claim 8, further comprising:
receiving, by the processor, a carrier waveform (CW) from the reader apparatus, wherein the CW is used to provide energy to the IoT device.

13. The method of claim 12, wherein the CW is received in at least one of an uplink (UL) spectrum and a downlink (DL) spectrum for the OFDM signal, and wherein the CW is received from inside a system for the OFDM signal in the DL spectrum, or the CW is received from inside the system for the OFDM signal in the UL spectrum, or the CW is received from outside the system for the OFDM signal in the UL spectrum.

14. An apparatus, comprising:
a transceiver which, during operation, wirelessly communicates with at least one network node of a wireless network; and
a processor communicatively coupled to the transceiver such that, during operation, the processor performs operations comprising:
transmitting, via the transceiver, a message to an Internet of Things (IoT) device through an in-band frequency or a guard band frequency in a frequency spectrum for an orthogonal frequency division multiplexing (OFDM) signal, wherein a start of the transmission is aligned with a boundary of an OFDM symbol of the OFDM signal; and
receiving, via the transceiver, a backscattered IoT signal from the IoT device through the in-band frequency or the guard band frequency.

15. The apparatus of claim 14, wherein the in-band frequency is configured for an uplink (UL) transmission or a downlink (DL) transmission of the OFDM signal.

16. The apparatus of claim 14, wherein the guard band frequency is configured between two OFDM signals.

17. The apparatus of claim 14, wherein an IoT guard band frequency is configured between the OFDM signal and an IoT signal.

18. The apparatus of claim 14, wherein the processor is further configured to perform operations comprising:
transmitting, via the transceiver, a carrier waveform (CW) to the IoT device, wherein the CW is configured to provide energy to the IoT device.

19. The apparatus of claim 18, wherein the CW is transmitted in at least one of an uplink (UL) spectrum and a downlink (DL) spectrum for the OFDM signal, and wherein the CW is transmitted from inside a system for the OFDM signal in the DL spectrum, or the CW is transmitted from inside the system for the OFDM signal in the UL spectrum, or the CW is transmitted from outside the system for the OFDM signal in the UL spectrum.

20. The apparatus of claim 18, wherein the CW is transmitted through a carrier resource of the message or through another carrier resource.

21. An apparatus, comprising:
a transceiver which, during operation, wirelessly communicates with a reader apparatus; and
a processor communicatively coupled to the transceiver such that, during operation, the processor performs operations comprising:
receiving, via the transceiver, a message from the reader apparatus through an in-band frequency or a guard band frequency in a frequency spectrum for an orthogonal frequency division multiplexing (OFDM) signal, wherein a start of the reception is aligned with a boundary of an OFDM symbol of the OFDM signal; and
performing a backscattering transmission through the in-band frequency or the guard band frequency to transmit a backscattered IoT signal to the reader apparatus.

22. The apparatus of claim 21, wherein the in-band frequency is configured for an uplink (UL) transmission or a downlink (DL) transmission of the OFDM signal.

23. The apparatus of claim 21, wherein the guard band frequency is configured between two OFDM signals.

24. The apparatus of claim 21, wherein an IoT guard band frequency is configured between the OFDM signal and an IoT signal.

25. The apparatus of claim 21, wherein the processor is further configured to perform operations comprising:
receiving, via the transceiver, a carrier waveform (CW) from the reader apparatus, wherein the CW is used to provide energy to the IoT device.

26. The apparatus of claim 25, wherein the CW is received in at least one of an uplink (UL) spectrum and a downlink (DL) spectrum for the OFDM signal, and wherein the CW is received from inside a system for the OFDM signal in the DL spectrum, or the CW is received from inside the system for the OFDM signal in the UL spectrum, or the CW is received from outside the system for the OFDM signal in the UL spectrum.
